(19) United States
(12) Patent Application Publication
(10) Pub. No.: US 2025/0024302 A1
(43) Pub. Date: Jan. 16, 2025

(54) SENSING SIGNAL PROCESSING METHOD, DEVICE, AND READABLE STORAGE MEDIUM

(71) Applicant: VIVO MOBILE COMMUNICATION CO., LTD., Dongguan (CN)

(72) Inventors: Dajie JIANG, Dongguan (CN); Jian YAO, Dongguan (CN); Shengli DING, Dongguan (CN); Jianzhi LI, Dongguan (CN); Yannan YUAN, Dongguan (CN)

(73) Assignee: VIVO MOBILE COMMUNICATION CO., LTD., Dongguan (CN)

(21) Appl. No.: 18/900,862

(22) Filed: Sep. 29, 2024

Related U.S. Application Data
(63) Continuation of application No. PCT/CN2023/085569, filed on Mar. 31, 2023.

(30) Foreign Application Priority Data
Apr. 2, 2022 (CN) 202210351167.7

(51) Int. Cl. H04W 24/10; H04W 4/38; H04W 24/08

(52) U.S. Cl. CPC H04W 24/10; H04W 4/38; H04W 24/08

(57) ABSTRACT

This application discloses a sensing signal processing method, a device, and a readable storage medium. The method includes: receiving, by a first sensing device, a first sensing signal; and performing, by the first sensing device, fuzzification processing on the first sensing signal to obtain a first sensing measurement quantity; or determining, by the first sensing device, an initial sensing measurement quantity based on the first sensing signal, and performing fuzzification processing on the initial sensing measurement quantity to obtain the first sensing measurement quantity.

### CROSS-REFERENCE TO RELATED APPLICATIONS

This application is a continuation of International Application No. PCT/CN 2023/085569, filed on Mar. 31, 2023, which claims priority to Chinese Patent Application No. 202210351167.7, filed in China on Apr. 2, 2022. The entire contents of each of the above-referenced applications are expressly incorporated herein by reference.

### TECHNICAL FIELD

This application pertains to the field of communication technologies, and in particular, to a sensing signal processing method, a device, and a readable storage medium.

### BACKGROUND

At present, security, trustworthiness, and privacy have become one of the important demands of the 6th Generation (6G) mobile communication network. Some results obtained by wireless sensing are private, leading to security risks or information leakage risks.

### SUMMARY

Embodiments of this application provide a sensing signal processing method, a device, and a readable storage medium.

According to a first aspect, a sensing signal processing method is provided, including:
receiving, by a first sensing device, a first sensing signal; and
performing, by the first sensing device, fuzzification processing on the first sensing signal to obtain a first sensing measurement quantity;
or
determining, by the first sensing device, an initial sensing measurement quantity based on the first sensing signal, and performing fuzzification processing on the initial sensing measurement quantity to obtain the first sensing measurement quantity.

According to a second aspect, a sensing signal processing method is provided, including:
sending, by a second sensing device, a first sensing signal corresponding to first information to a first sensing device, so that the first sensing device performs fuzzification processing on the first sensing signal to obtain a first sensing measurement quantity, or the first sensing device determines an initial sensing measurement quantity based on the first sensing signal, and performs fuzzification processing on the initial sensing measurement quantity to obtain a first sensing measurement quantity; where
the first information includes parameter information of a sensing signal and/or resource information of the sensing signal.

According to a third aspect, a sensing signal processing method is provided, including:
sending, by a first network-side device, a first requirement to a second sensing device, so that the second sensing device determines second information based on the first requirement;
or
determining, by the first network-side device, the second information based on the first requirement, and sending, by the first network-side device, the second information to the second sensing device; where
the first requirement includes at least one of the following: a fuzzification requirement related to wireless sensing, a sensing privacy requirement, and a sensing error requirement; and the second information includes at least one of parameter information of a sensing signal and resource information of the sensing signal.

According to a fourth aspect, a sensing signal processing method is provided, including:
sending, by a second network-side device, a first requirement to a second sensing device, so that the second sensing device determines second information based on the first requirement;
or
determining, by the second network-side device, the second information based on the first requirement, and sending, by the second network-side device, the second information to the second sensing device; where
the first requirement includes at least one of the following: a fuzzification requirement related to wireless sensing, a sensing privacy requirement, and a sensing error requirement; and the second information includes at least one of parameter information of a sensing signal and resource information of the sensing signal.

According to a fifth aspect, a sensing signal processing apparatus is provided, including:
a first receiving module, configured for a first sensing device to receive a first sensing signal; and
a first processing module configured to: for the first sensing device, perform fuzzification processing on the first sensing signal to obtain a first sensing measurement quantity; or for the first sensing device, determine an initial sensing measurement quantity based on the first sensing signal, and perform fuzzification processing on the initial sensing measurement quantity to obtain the first sensing measurement quantity.

According to a sixth aspect, a sensing signal processing apparatus is provided, including:
a second processing module configured to: for a second sensing device, send a first sensing signal corresponding to first information to a first sensing device, so that the first sensing device performs fuzzification processing on the first sensing signal to obtain a first sensing measurement quantity, or the first sensing device determines an initial sensing measurement quantity based on the first sensing signal, and performs fuzzification processing on the initial sensing measurement quantity to obtain a first sensing measurement quantity; where
the first information includes parameter information of a sensing signal and/or resource information of the sensing signal.

According to a seventh aspect, a sensing signal processing apparatus is provided, including:
a third processing module configured to: send, for a first network-side device, a first requirement to a second sensing device, so that the second sensing device determines second information based on the first requirement;
or
determine, for the first network-side device, the second information based on the first requirement, and send, for the first network-side device, the second information to the second sensing device; where
the first requirement includes at least one of the following: a fuzzification requirement related to wireless sensing, a sensing privacy requirement, and a sensing error requirement; and the second information includes at least one of parameter information of a sensing signal and resource information of the sensing signal.

According to an eighth aspect, a sensing signal processing apparatus is provided, including:
a fourth processing module configured to: send, for a second network-side device, a first requirement to a second sensing device, so that the second sensing device determines second information based on the first requirement;
or
determine, for the second network-side device, the second information based on the first requirement, and send, for the second network-side device, the second information to the second sensing device; where
the first requirement includes at least one of the following: a fuzzification requirement related to wireless sensing, a sensing privacy requirement, and a sensing error requirement; and the second information includes at least one of parameter information of a sensing signal and resource information of the sensing signal.

According to a ninth aspect, a sensing signal processing system is provided, including: a first sensing device, a second sensing device, a first network-side device, and a second network-side device; where the first network-side device is an access network device accessed by the second sensing device in a case that the second sensing device is a terminal;
the second network-side device is a sensing network function or a sensing network element; and
the first sensing device may be configured to perform the steps of the sensing signal processing method according to the first aspect, the second sensing device may be configured to perform the steps of the sensing signal processing method according to the second aspect, the first network-side device may be configured to perform the steps of the sensing signal processing method according to the third aspect, and the second network-side device may be configured to perform the steps of the sensing signal processing method according to the fourth aspect.

According to a tenth aspect, a terminal is provided, where the terminal includes a processor and a memory, and a program or instructions capable of running on the processor are stored in the memory. When the program or the instructions are executed by the processor, the steps of the sensing signal processing method according to the first aspect are implemented, and the second sensing device may be configured to perform the steps of the sensing signal processing method according to the second aspect.

According to an eleventh aspect, a terminal is provided, including a processor and a communication interface, where the communication interface is configured to receive, for a first sensing device, a first sensing signal; and
the processor is configured to perform, for the first sensing device, fuzzification processing on the first sensing signal to obtain a first sensing measurement quantity;
or
determine, for the first sensing device, an initial sensing measurement quantity based on the first sensing signal, and perform fuzzification processing on the initial sensing measurement quantity to obtain the first sensing measurement quantity;
or
the communication interface is configured to: for a second sensing device, send a first sensing signal corresponding to first information to a first sensing device, so that the first sensing device performs fuzzification processing on the first sensing signal to obtain a first sensing measurement quantity, or the first sensing device determines an initial sensing measurement quantity based on the first sensing signal, and performs fuzzification processing on the initial sensing measurement quantity to obtain a first sensing measurement quantity; where
the first information includes parameter information of a sensing signal and/or resource information of the sensing signal.

According to a twelfth aspect, a network-side device is provided, where the network-side device includes a processor and a memory, and a program or instructions capable of running on the processor are stored in the memory. When the program or the instructions are executed by the processor, the steps of the sensing signal processing method according to the first aspect, the steps of the sensing signal processing method according to the second aspect, the steps of the sensing signal processing method according to the third aspect, and the steps of the sensing signal processing method according to the fourth aspect are implemented.

According to a thirteenth aspect, a network-side device is provided, including a processor and a communication interface, where the communication interface is configured to receive, for a first sensing device, a first sensing signal; and
the processor is configured to perform, for the first sensing device, fuzzification processing on the first sensing signal to obtain a first sensing measurement quantity;
or
determine, for the first sensing device, an initial sensing measurement quantity based on the first sensing signal, and perform fuzzification processing on the initial sensing measurement quantity to obtain the first sensing measurement quantity;
or
the communication interface is configured to: for a second sensing device, send a first sensing signal corresponding to first information to a first sensing device, so that the first sensing device performs fuzzification processing on the first sensing signal to obtain a first sensing measurement quantity, or the first sensing device determines an initial sensing measurement quantity based on the first sensing signal, and performs fuzzification processing on the initial sensing measurement quantity to obtain a first sensing measurement quantity; where
the first information includes parameter information of a sensing signal and/or resource information of the sensing signal.
or
the communication interface is configured to send, for a first network-side device, a first requirement to a second sensing device, so that the second sensing device determines second information based on the first requirement;
or
determine, for the first network-side device, the second information based on the first requirement, and send, for the first network-side device, the second information to the second sensing device; where
the first requirement includes at least one of the following: a fuzzification requirement related to wireless sensing, a sensing privacy requirement, and a sensing error requirement; and the second information includes at least one of parameter information of a sensing signal and resource information of the sensing signal;
or
the communication interface is configured to send, for a second network-side device, a first requirement to a second sensing device, so that the second sensing device determines second information based on the first requirement;
or
determine, for the second network-side device, the second information based on the first requirement, and send, for the second network-side device, the second information to the second sensing device; where
the first requirement includes at least one of the following: a fuzzification requirement related to wireless sensing, a sensing privacy requirement, and a sensing error requirement; and the second information includes at least one of parameter information of a sensing signal and resource information of the sensing signal.

According to a fourteenth aspect, a readable storage medium is provided, where a program or instructions are stored in the readable storage medium, and when the program or the instructions are executed by a processor, the steps of the sensing signal processing method according to the first aspect, the steps of the sensing signal processing method according to the second aspect, the steps of the sensing signal processing method according to the third aspect, and the steps of the sensing signal processing method according to the fourth aspect are implemented.

According to a fifteenth aspect, a chip is provided, where the chip includes a processor and a communication interface, the communication interface is coupled to the processor, and the processor is configured to run a program or instructions to implement the steps of the sensing signal processing method according to the first aspect, the steps of the sensing signal processing method according to the second aspect, the steps of the sensing signal processing method according to the third aspect, and the steps of the sensing signal processing method according to the fourth aspect.

According to a sixteenth aspect, a computer program/program product is provided, where the computer program/program product is stored in a storage medium, and when the computer program/program product is executed by at least one processor, the steps of the sensing signal processing method according to the first aspect, the steps of the sensing signal processing method according to the second aspect, the steps of the sensing signal processing method according to the third aspect, and the steps of the sensing signal processing method according to the fourth aspect are implemented.

In the embodiments of this application, the device receiving the sensing signal performs fuzzification processing in the process of detecting the sensing signal to obtain the sensing measurement quantity, or in the process of converting the initial sensing measurement quantity into the sensing measurement quantity, which not only meets privacy of a wireless sensing result, but also meets a sensing requirement.

### BRIEF DESCRIPTION OF DRAWINGS

FIG. 1a is a block diagram of a wireless communication system according to an embodiment of this application;

FIG. 1b is a schematic diagram of a sensing link in the related art;

FIG. 2 is a first schematic flowchart of a sensing signal processing method according to an embodiment of this application;

FIG. 3 is a second schematic flowchart of a sensing signal processing method according to an embodiment of this application;

FIG. 4 is a third schematic flowchart of a sensing signal processing method according to an embodiment of this application;

FIG. 5 is a fourth schematic flowchart of a sensing signal processing method according to an embodiment of this application;

FIG. 6 is a first schematic structural diagram of a sensing signal processing apparatus according to an embodiment of this application;

FIG. 7 is a second schematic structural diagram of a sensing signal processing apparatus according to an embodiment of this application;

FIG. 8 is a third schematic structural diagram of a sensing signal processing apparatus according to an embodiment of this application;

FIG. 9 is a fourth schematic structural diagram of a sensing signal processing apparatus according to an embodiment of this application;

FIG. 10 is a schematic structural diagram of a communication device according to an embodiment of this application;

FIG. 11 is a schematic structural diagram of a terminal according to an embodiment of this application;

FIG. 12 is a first schematic structural diagram of a network-side device according to an embodiment of this application; and

FIG. 13 is a second schematic structural diagram of a network-side device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

In the specification and claims of this application, the terms such as “first” and “second” are intended to distinguish between similar objects but do not necessarily indicate a specific order or sequence. It should be understood that the data used in this way is interchangeable in appropriate circumstances so that the embodiments of this application can be implemented in other orders than the order illustrated or described herein, and “first” and “second” are usually for distinguishing same-type objects but not limiting the number of objects, for example, there may be one or more first objects. In addition, “and/or” in this specification and claims indicates at least one of connected objects, and the symbol “/” generally indicates that the associated objects are in an “or” relationship.

It should be noted that techniques described in the embodiments of this application are not limited to a Long Term Evolution (LTE) or LTE-Advanced (LTE-A) system, and may also be applied to various wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are usually used interchangeably. Techniques described herein may be used in the aforementioned systems and radio technologies, and may also be used in other systems and radio technologies. In the following descriptions, a New Radio (NR) system is described for an illustration purpose, and NR terms are used in most of the following descriptions, although these technologies may also be applied to other applications than an NR system application, for example, the 6G communication system.

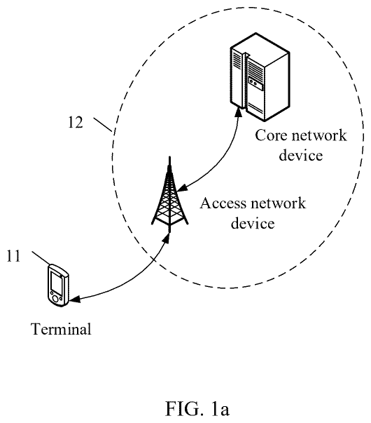

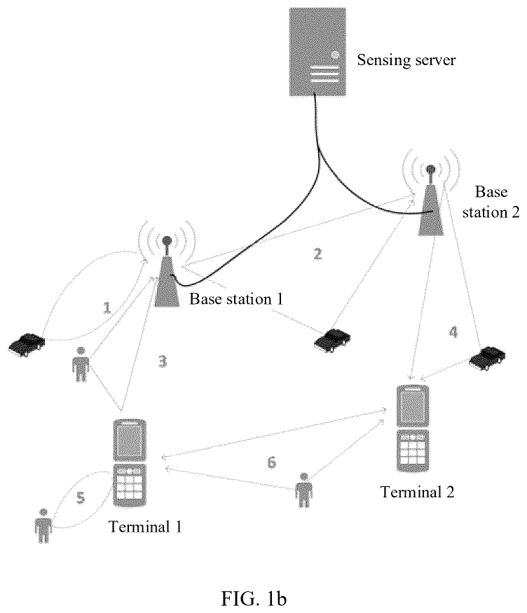

FIG. 1a is a block diagram of a wireless communication system to which the embodiments of this application are applicable. The wireless communication system includes a terminal 11 and a network-side device 12. The terminal 11 may be a terminal-side device, such as a mobile phone, a tablet computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (a home device with wireless communication function, such as a refrigerator, a television, a washing machine, or a furniture), a game console, a Personal Computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, game console, and the like. It should be noted that a specific type of the terminal 11 is not limited in the embodiments of this application. The network-side device 12 may include an access network device or a core network device, where the access network device may also be referred to as a radio access network device, a Radio Access Network (RAN), a radio access network function, or a radio access network unit. The access network device may include a base station, a Wireless Local Area Network (WLAN) access point, a Wireless Fidelity (WiFi) node, or the like. The base station may be referred to as a NodeB, an evolved NodeB (CNB), an access point, a Base Transceiver Station (BTS), a radio base station, a radio transceiver, a Basic Service Set (BSS), an (Extended Service Set (ESS), a home NodeB, a home evolved NodeB, a Transmission Reception Point (TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, a core network device in an NR system is used as an example for description, and a specific type of the core network device is not limited.

To better understand the technical solutions in the embodiments of this application, the following content is first described.

Future mobile communication systems, such as Beyond 5th Generation (B5G) systems or 6G systems, will not only have communication capabilities, but also have sensing capabilities.

For sensing capability, one or more devices with sensing capability can transmit and receive radio signals to sense information such as orientation, distance, and speed of a target object, or to perform detection, tracking, identification, and imaging of a target object, event, or environment. In the future, with the deployment of small cell base stations with high frequency band and large bandwidth such as millimeter wave and terahertz in 6G networks, the sensing resolution will be significantly improved compared with centimeter wave, thus enabling 6G networks to provide more detailed sensing services. Typical sensing functions and application scenarios are shown in Table 1.

TABLE 1

| Communication- | | |
|---|---|---|
| sensing | | |
| category | Sensing function | Application scenario |
| Macroscopic | Weather, air quality, and | Meteorological, |
| sensing | the like | agricultural, and living |
| | | services |
| | Traffic flow (intersection) | Intelligent transportation |
| | and crowd flow (subway | and business services |
| | entrance) | |
| | Target tracking, ranging, | Many application |
| | speed measurement, | scenarios of traditional |
| | contour, and the like | radars |
| | Environmental | Intelligent driving, |
| | reconstruction | navigation (car/drone), |
| | | smart city (3 D map), |
| | | smart city, network |
| | | planning, and network |
| | | optimization. |
| Refined sensing | Action/posture/expression | Intelligent interaction of |
| | recognition | smart phones, games and |
| | | smart home |
| | Heartbeat/breathing or the | Health care and medical |
| | like | care |
| | Imaging, material | Safety inspection, |
| | detection, composition | industry, biomedicine, |
| | analysis, and the like | and the like |

The integration of communication and sensing is to implement integrated design of communication and sensing functions through spectrum sharing and hardware sharing in a same system. While transmitting information, the system may sense information such as azimuth, distance, and speed, to detect, track and identify a target device or event. The communication system and the sensing system complement each other, thus improving overall performance and bringing better service experience.

The integration of communication and radar is a typical application of the integration of communication and sensing (fusion of communication and sensing). In the past, the radar system and communication system were strictly distinguished because of different research objects and focus, and the two systems were studied independently in most scenarios. Actually, the radar and communication systems are also typical ways of information transmission, acquisition, processing, and exchange, and there are many similarities in working principle, system architecture, and frequency band. The integrated design of communication and radar has great feasibility, which is mainly reflected in the following aspects: firstly, both the communication system and the sensing system are based on the electromagnetic wave theory, and implement information acquisition and transmission through transmission and reception of electromagnetic wave; secondly, both the communication system and the sensing system have structures such as an antenna, a transmitter, a receiver, and a signal processor, greatly overlapping in hardware resources. With the development of technologies, the two increasingly overlap in the working frequency band. In addition, there are similarities in key technologies such as signal modulation, reception detection, and waveform design. The integration of communication and radar systems may bring many advantages, such as saving cost, reducing size, reducing power consumption, improving spectrum efficiency, and reducing mutual interference, thus improving overall performance of the system.

According to the difference between a transmitting node and a receiving node of the sensing signal, there may be the following six types of sensing links, as shown in FIG. 1b. It should be noted that in FIG. 1b, each type of sensing link uses one transmitting node and one receiving node as an example. In an actual system, different sensing links may be selected based on different sensing requirements, each type of sensing link may have one or more transmitting nodes and receiving nodes, and an actual sensing system may include a variety of different types of sensing links. Sensing objects in FIG. 1b use people and cars as examples, and sensing objects in an actual system may be more abundant.

1) Echo sensing for a base station. In this manner, the base station sends a sensing signal and obtains a sensing result by receiving echo of the sensing signal.

2) Air interface sensing between base stations. In this manner, a base station 2 receives a sensing signal sent by a base station 1 and obtains a sensing result.

3) Uplink air interface sensing. In this manner, a base station receives a sensing signal sent by User Equipment (UE) and obtains a sensing result.

4) Downlink air interface sensing. In this manner, the UE receives a sensing signal sent by the base station and obtains a sensing result.

5) Echo sensing for a terminal. In this manner, the UE sends a sensing signal and obtains a sensing result by receiving echo of the sensing signal.

6) Sidelink sensing between terminals. For example, UE 2 receives a sensing signal sent by UE 1 and obtains a sensing result.

The following describes in detail a sensing signal processing method provided in the embodiments of this application by using some embodiments and application scenarios thereof with reference to the accompanying drawings.

First, the terms involved in the embodiments of this application are explained and described:

### 1. First Requirement

The first requirement includes a fuzzification requirement related to wireless sensing, a sensing privacy requirement, or a sensing error requirement. For example:

a) Fuzzification requirement/privacy requirement for a position of a sensed sensing object, such as a position of the sensing object plus a random deviation in a range of −1 m to 1 m or a random angle error of −5 degrees to +5 degrees for angle information.

b) Adding a deviation to trajectory information. Trajectory consists of multiple positions at different times. To keep trajectory of fuzzification processing continuous, position errors at different times need to be consistent.

c) Sensing characteristics of a sensing object, such as a human body, for example, scanning body contour characteristics of a person through radio signals, merely for the purpose of virtual fitting, instead of obtaining more detailed information for other purposes. In this case, the first requirement may be a minimum 3D sensing resolution, for example, 5 cm×5 cm×5 cm.

d) Imaging: for example, imaging results of some sensing objects feature privacy.

For example, for face information, 2D information of face may be obtained by radio signal scanning. In this case, the first requirement may be a minimum 2D sensing resolution, such as 2 cm×2 cm. In this case, the first requirement is not to display a sensing result of human face, but only to display a sensing result of other human parts.

e) Map construction/3D environment reconstruction: Map information or environment reconstruction information of some sensitive areas or sensitive buildings belongs to private information. In this case, the first requirement includes characteristic information of the sensitive areas or sensitive buildings, such as location information, and a minimum resolution for map construction of the sensitive areas or sensitive buildings (for example, the minimum resolution of map construction of the sensitive areas or sensitive buildings is 10 m×10 m×10 m, and other non-sensitive areas are 1 m×1 m×1 m).

f) Radar: For example, results of ranging, speed measurement, and angle measurement by radar, and sensing results for some sensing objects may be private. In this case, the first requirement is a resolution requirement for ranging, speed measurement, and angle measurement of some sensing objects, such as a minimum velocity resolution of 1 meter per second, a minimum distance resolution of 10 meters, and a minimum angle resolution of 10 degrees. For another example, the first requirement in this case is to add one absolute error to the result of ranging, speed measurement, and angle measurement, or add a relative error such as a 10% error to the result of ranging, speed measurement and angle measurement.

g) Minimum granularity requirement or quantification requirement of human heart rate and respiratory rate obtained through wireless sensing, for example, the granularity of the minimum heartbeat frequency is 5 times/minute, and the granularity of minimum respiratory frequency is 2 times/minute.

h) Health: Information such as blood oxygen, blood pressure, or sleep quality belongs to personal private information. The first requirement in this case is, for example, the granularity of minimum blood oxygen or blood pressure.

Note: The first requirement may further include a fuzzification mode. For the specific fuzzification mode, refer to the following related descriptions.

### 2. First Information/Second Information: Interpretation of Parameter Information and Resource Information of the Sensing Signal.

The parameter information of the sensing signal includes at least one of the following:

a) Waveforms, such as Orthogonal Frequency Division Multiplexing (OFDM) and Single-carrier Frequency-Division Multiple Access (SC-FDMA), Orthogonal Time Frequency Space (OTFS), Frequency Modulated CW (FMCW), or pulse signal.

b) Subcarrier spacing, for example, a subcarrier spacing of the OFDM system is 30 KHz.

c) Guard period, that is, a time interval from an end time of sending a signal to a time of receiving the latest echo signal of the signal, where the parameter is proportional to a maximum sensing distance and for example, can be calculated by 2 dmax/c, dmax being a maximum sensing distance (belonging to the sensing requirement). For another example, for a sensing signal spontaneously sent and received, dmax represents a maximum distance from a sensing signal receive point to a signal transmit point. In some cases, a Cyclic Prefix (CP) of OFDM signals can act as a minimum guard period; where c represents the speed of light.

d) Bandwidth: this parameter is inversely proportional to a distance resolution and can be obtained by c/2/delta_d, where delta_d represents a distance resolution (belonging to the sensing requirement).

e) Burst duration: this parameter is inversely proportional to a rate resolution (belonging to the sensing requirement), and this parameter is a time span of the sensing signal, mainly for calculating Doppler frequency shift; this parameter can be calculated by c/2/delta_v/fc, where delta_v represents a velocity resolution, and fc represents a carrier frequency of the signal or a central frequency of the signal.

f) Time domain interval, where this parameter can be calculated by c/2/fc/v_range; v_range represents a maximum rate minus a minimum speed (belonging to the sensing requirement), and this parameter is a time interval between two adjacent sensing signals.

g) Power information of a transmitted signal includes transmission power, peak power, average power, total power, power spectral density, Effective Isotropic Radiated Power (EIRP), power of each port, and the like. For example, a value of the transmission power is taken every 2 dBm from −20 dBm to 23 dBm; and a value of the transmit signal power or EIRP, for example, is taken every 2 dBm from −20 dBm to 23 dBm.

h) Signal format, such as Sounding Reference Signal (SRS), Demodulation Reference Signal (DMRS), Positioning Reference Signal (PRS), or other predefined signals, and related sequence format (sequence format is associated with sequence content, sequence length, or the like) and other information.

i) Signal direction, such as a sensing signal direction or beam information.

j) Beam information or Quasi co-location (QCL) relationship, where for example, the sensing signal includes a plurality of resources, and each resource corresponds to one Synchronization Signal and PBCH block (SSB) QCL, and a type of QCL includes type A (Type A), type B (Type B), type C (Type C), or type D (Type D);

k) Antenna configuration parameter (applicable to transmission and reception of sensing signals by multi-antenna devices), for example, at least one of orthogonal transmission antenna mode (Time Division Multiplexing (TDM)/Code Division Multiplexing (CDM)/Frequency Division Multiplexing (FDM)/Doppler Division Multiplexing (DDM), the number of antenna ports, the number of antenna elements, a distance between antenna elements, the number of receiving channels, the number of transmitting channels, the number of transmitting antennas, and the number of (maximum) uplink or downlink Multi Input Multi Output (MIMO) layers.

The resource information of the sensing signal includes at least one of the following:
a) time resource, such as a slot index or symbol index of a slot in which the sensing signal is located; where there are two types of time resources, one is a one-off time resource, for example, one omnidirectional first signal is sent on one symbol; the other is a non-one-off time resource, such as a plurality of groups of periodic time resources or discontinuous time resources (which may include a start time and an end time), sensing signals in the same direction are sent on each group of periodic time resources, and beam directions for different groups of periodic time resources are different; and
b) frequency resource, including a central frequency of the sensing signal, bandwidth, Radio Bearer (RB) or subcarrier, or the like.

### 3. Sensing Requirement (Also Referred to as Second Requirement)

The sensing requirement includes at least one of the following:
sensing target area: indicates a location area where the sensing object may exist, or a location area that needs imaging or three-dimensional reconstruction;
sensing object type: sensing objects are classified based on their possible motion characteristics, and each sensing object type contains information such as motion speed, motion acceleration, and typical Radar Cross Section (RCS) of typical sensing objects; and
Quality of Service (QOS): a performance index for sensing a target area or a sensing object, including at least one of the following: sensing resolution (further divided into ranging resolution, angle measurement resolution, speed measurement resolution, and imaging resolution), sensing accuracy (further divided into ranging accuracy, angle measurement accuracy, speed measurement accuracy, and positioning accuracy), sensing range (further divided into: ranging range, speed range, angle range, and imaging range), sensing delay (a time interval from sending of a sensing signal to obtaining of a sensing result, or a time interval from initiation of a sensing requirement to obtaining of a sensing result), sensing update rate (a time interval between two times of consecutive sensing and obtaining of a sensing result), detection probability (a probability of being correctly detected in presence of a sensing object), and false alarm probability (a probability of being incorrectly detected in absence of a sensing object).

### 4. Sensing Measurement Quantity and Measurement Configuration Information

The sensing measurement quantity includes at least one of the following (primary measurement quantity): complex value, amplitude, phase, I-channel data, Q-channel data, channel matrix, channel state information, reference signal received power, received signal strength indicator, channel power delay spectrum, Doppler power spectrum, Doppler spread, coherence bandwidth, coherence time, angle, power of each path in multipath channel, delay of each path in multipath channel, angle of each path in multipath channel, Doppler frequency shift, and Time of flight (ToF), RCS, quotient of frequency domain channel responses of the first antenna and the second antenna, conjugate multiplication of frequency domain channel responses of the first antenna and the second antenna, amplitude ratio of received signals of the first antenna and the second antenna, amplitude difference of received signals of the first antenna and the second antenna, phase difference of the first antenna and the second antenna, and angle related information of the first antenna and the second antenna for a received sensing signal or a sensing signal channel response; where the first antenna and the second antenna are receive antennas of the first device.

The sensing measurement quantity may, for example, be a measurement quantity (secondary measurement quantity) obtained by simple operation of at least one of the above items (primary measurement quantity) or a measurement quantity (secondary measurement quantity) obtained by complex operation of at least one of the above items. Algorithms for obtaining the secondary measurement quantity based on the primary measurement quantity may include: addition, subtraction, multiplication, and division; matrix addition, subtraction, and multiplication; matrix transposition; trigonometric relation operation; square root operation; power operation; and the like, as well as a threshold detection result and maximum/minimum extraction results of the above operation results. The above complex operation includes Fast Fourier Transform (FFT)/Inverse Fast Fourier Transform (IFFT), Discrete Fourier Transform (DFT)/Inverse Discrete Fourier Transform (IDFT), 2D-FFT, 3D-FFT, matched filtering, autocorrelation operation, wavelet transform and digital filtering, as well as a threshold detection result and maximum/minimum extraction results of the above operation results.

The measurement configuration information includes: identification information of the sensing signal corresponding to the measurement quantity (such as sensing signal information corresponding to the sensing measurement quantity, time information and frequency information of the sensing measurement quantity, information about a base station or TRP sending the sensing signal, information about an antenna port sending the sensing signal, or information about a receive antenna of the third device), a measurement period, and the like.

### 5. Sensing Result

Including Shape, 2D/3D environment reconstruction, spatial position, orientation, displacement, moving speed, and acceleration of a sensing object; speed measurement, distance measurement and angle measurement/imaging of target objects for radar-like sensing; whether people/things exist; and

further including: movement, gesture, breathing frequency, heartbeat frequency, sleep quality, and the like of a sensing object such as human.

### 6. Fuzzification Mode

The fuzzification of the sensing measurement quantity or the sensing result may be performed in at least one of the following processes:

(1) Performing fuzzification processing on a sensing signal to obtain a sensing measurement quantity. For example, fuzzification processing is performed on a received sensing signal or sensing signal channel response, including fuzzification processing on a complex value, amplitude, phase, I-channel data, or Q-channel data of the received sensing signal or sensing signal channel response, and then the sensing measurement quantity is obtained based on a complex value, amplitude, phase, I-channel data, or Q-channel data of the fuzzified sensing signal or sensing signal channel response. The sensing measurement quantity includes delay, Doppler, angle, signal strength, and the like.

(2) Determining an initial sensing measurement quantity based on the sensing signal, and performing fuzzification processing on the initial sensing measurement quantity to obtain a new sensing measurement quantity. For example, the initial sensing measurement quantity such as delay, Doppler, angle, and intensity is determined based on the sensing signal, and then fuzzification processing is performed on the initial sensing measurement quantity to obtain new sensing measurement quantities such as distance, speed, orientation, spatial position, and acceleration.

(3) Performing fuzzification processing during generating of a sensing result based on the sensing measurement quantity.

(4) Performing fuzzification processing during generating of a (N+1)-level sensing result from a N-level sensing result, (N is an integer ≥1).

The fuzzification mode includes at least one of the following:

(1) Adding noise to the sensing measurement quantity or the sensing result:

Noise includes high-frequency noise or low-frequency noise. For example, a detail component is generally reflected in high frequency; therefore, if the first requirement is to display only the sensing contour, adding high-frequency noise may be considered.

Noise also includes random noise and continuous noise, and the continuous noise includes Perlin noise, Worley noise, fractal noise, curl noise, and the like.

(2) Adding errors to the sensing measurement quantity or the sensing result, including biased error (an average value of random errors is not 0) or unbiased error (an average value of random errors is 0).

(3) Part of the information is removed (or down-sampled) from the sensing measurement quantity or the sensing result.

(4) Reducing a sampling rate of the sensing measurement quantity or the sensing result, such as reducing an image sampling rate of a sensing imaging result, or cutting out some pixel points, or using an average value of N adjacent pixel points (N is an integer greater than 1).

(5) Reducing a resolution of the sensing measurement quantity or sensing result, for example, dividing a measured speed/distance/angle information into ranges, and replacing measurement quantities or sensing results falling within a range by an upper or lower limit, arithmetic average, or geometric average of the range.

Note: Fuzzification processing may be performed on the sensing measurement quantity by frequency band/time/antenna, or on the sensing measurement quantity or sensing result by coordinate/Heatmap area (for example, only for coordinate areas with high privacy requirement).

### 7. Feedback Configuration Information for the Sensing Measurement Quantity:

The feedback configuration information for the sensing measurement quantity includes at least one of the following:
feeding back time domain resources of the target sensing measurement quantity;
feeding back frequency domain resources of the target sensing measurement quantity; and
feeding back a granularity or step size of the target sensing measurement quantity.
   8. QCL relationship.

Quasi co-location indicates that when channel characteristics of one antenna port symbol may be deduced from another antenna port, it is considered that the two ports are QCLed and a channel estimation result obtained from one port may be used for the other port. For example, it may be considered that the two ports are from a same transmission source. The QCL configuration may include many different signal types, such as Channel State Information Reference Signal (CSI-RS), SSB, or SRS. The network-side device may configure corresponding QCL configurations for different beams. The network-side device may change a QCL configuration of a terminal (UE) to change a beam that the terminal (UE) works.

There are four types of QCL in the 5G system, as shown in Table 2 below.

TABLE 2

| Type | Feature | Function |
|---|---|---|
| QCL-TypeA | Doppler shift, Doppler spread, | Obtaining channel |
| | average delay, delay spread | estimation information |
| QCL-TypeB | Doppler shift, Doppler spread | Obtaining channel |
| | | estimation information |
| QCL-TypeC | Doppler shift, average delay | Obtaining measurement |
| | | information such as RSRP |
| QCL-TypeD | Spatial receive (Rx receive) | Assisting terminal |
| | parameter | beamforming |

### 9. Sensing Signal

The sensing signal may be a signal with only sensing function but no communication function, such as LTE/NR synchronization signal or reference signal in related technologies. Such type of signal is based on pseudo-random sequence, including m sequence, Zadoff-Chu sequence, Gold sequence, and the like; or may be single frequency Continuous Wave (CW), Frequency Modulated CW (FMCW), and ultra-wideband Gaussian pulse commonly used in radar; or may be a newly designed special sensing signal with good correlation characteristics and low Peak-to-Average Power Ratio (PAPR), or a newly designed integrated communication-sensing signal with both sensing and communication functions. In this application, the foregoing sensing signal or integrated communication-sensing signal are collectively called sensing signal.

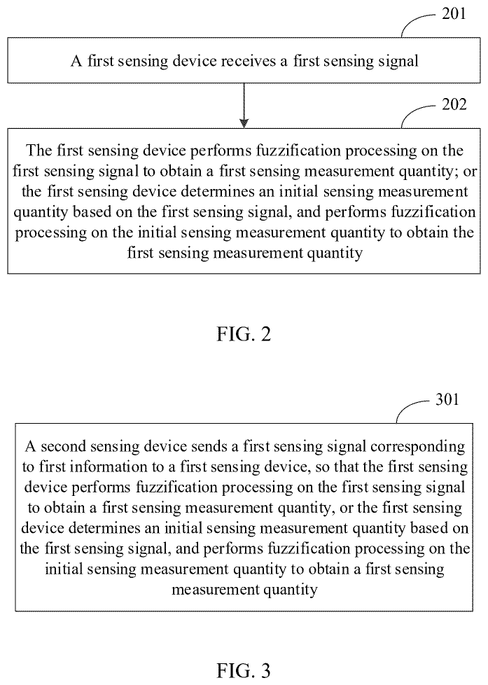

Referring to FIG. 2, an embodiment of this application provides a sensing signal processing method. The execution subject of the method is a first sensing device, and the method includes:

Step 201: The first sensing device receives a first sensing signal.

Step 202: The first sensing device performs fuzzification processing on the first sensing signal to obtain a first sensing measurement quantity; or the first sensing device determines an initial sensing measurement quantity based on the first sensing signal, and performs fuzzification processing on the initial sensing measurement quantity to obtain the first sensing measurement quantity.

The first sensing device performs fuzzification processing during generating of the first sensing measurement quantity, to obtain the first sensing measurement quantity; or, the first sensing device performs fuzzification processing on the initial sensing measurement quantity of the first sensing signal to obtain the first sensing measurement quantity.

In some embodiments, the step of performing, by the first sensing device, fuzzification processing on the first sensing signal to obtain a first sensing measurement quantity includes:
obtaining, by the first sensing device, the first sensing measurement quantity based on one or more of a first requirement, a second requirement, and a first fuzzification mode; and
the step of performing, by the first sensing device, fuzzification processing on the initial sensing measurement quantity to obtain the first sensing measurement quantity includes:
obtaining, by the first sensing device, the first sensing measurement quantity based on one or more of the first requirement, the second requirement, and a second fuzzification mode; where
the first requirement includes at least one of the following: a fuzzification requirement related to wireless sensing, a sensing privacy requirement, and a sensing error requirement; and the second requirement includes at least one of the following: a sensing target area, a sensing object type, and sensing quality of service QoS.

Obtaining the first sensing measurement quantity through fuzzification processing includes: obtaining the first sensing measurement quantity based on one or more of the first requirement, the second requirement, a first fuzzification mode, and a second fuzzification mode.

In some embodiments, the first fuzzification mode is determined based on the first requirement and/or the second requirement, and the second fuzzification mode is determined based on the first requirement and/or the second requirement.

The first requirement includes at least one of the following: a fuzzification requirement related to wireless sensing, a sensing privacy requirement, and a sensing error requirement; and the second requirement includes at least one of the following: a sensing target area, a sensing object type, and sensing quality of service QoS. The first fuzzification mode is used for fuzzification processing in the process of obtaining the first sensing measurement quantity. The second fuzzification mode is used for fuzzification processing in the process of converting the initial sensing measurement quantity into the first sensing measurement quantity.

The sensing measurement quantity can be understood by referring to the previous description of sensing measurement quantity, that is, the sensing measurement quantity may include a first-level sensing measurement quantity and a second-level sensing measurement quantity. The initial sensing measurement quantity corresponds to the first-level sensing measurement quantity. In other words, the first sensing device may perform fuzzification processing in the process of obtaining the first-level sensing measurement quantity, or the first sensing device may perform fuzzification processing in the process of obtaining the second-level sensing measurement quantity based on the first-level sensing measurement quantity, so as to obtain the final first sensing measurement quantity.

In this embodiment of this application, the device receiving the sensing signal performs fuzzification processing in the process of detecting the sensing signal to obtain the sensing measurement quantity, or in the process of converting the initial sensing measurement quantity into the sensing measurement quantity, which not only meets privacy of a wireless sensing result, but also meets a sensing requirement.

The first sensing device may also be referred to as a sensing signal receiving device, for example, the first sensing device may be a terminal or an access network device (such as a base station), and the concept of the first sensing device may be carried forward to other subsequent embodiments.

For details about the first requirement, the second requirement, the first fuzzification mode, and the second fuzzification mode, refer to the previous explanation and description related to the requirement and fuzzification mode, which is not be repeated here. It can be understood that specific contents of the first requirement and the second requirement may be the same or different, and specific contents of the first fuzzification mode and the second fuzzification mode may be the same or different, which is not specifically limited in the embodiments of this application.

Before the first sensing device detects the first sensing signal and obtains the first sensing measurement quantity, the technical solution in this embodiment of this application may further include the following steps.

In a possible implementation, the method further includes: receiving, by the first sensing device, a first sensing signal corresponding to first information from a second sensing device; where

the first information includes parameter information of a sensing signal and/or resource information of the sensing signal.

In this embodiment of this application, the second sensing device may also be referred to as a sensing signal transmitting device. Specifically, the second sensing device may be a terminal or an access network device (such as a base station), and the concept of the second sensing device may be carried forward to other subsequent embodiments.

In this embodiment of this application, the first information is sent by the sensing transmitting device to the sensing receiving device, and is used to enable the sensing receiving device to obtain related parameter information and/or resource information of the sensing signal, so that the sensing receiving device can receive the corresponding first sensing signal based on the first information.

It should be noted that there is a special case in the scenario of receiving and sending sensing signals: echo reception. In this case, the sensing signal transmitting device and the sensing signal receiving device are a same device, that is, the first sensing device and the second sensing device are a same device. At that time, it is unnecessary to perform the step that the first sensing device receives the second requirement from the second sensing device. Therefore, when the first sensing device and the second sensing device are a same device, it is equivalent that the first sensing device has learned the second requirement.

In the following operation steps related to interaction between the first sensing device and the second sensing device, it can be understood that for echo reception, the interaction between the first sensing device and the second sensing device may be omitted when the first sensing device and the second sensing device are a same device, which will not be described in detail later.

It should be noted that in this application, the first sensing device, the second sensing device, the first network-side device, and the second network-side device each are all described as one device, and this application is also applicable to a case that the number of first sensing devices, the number of second sensing devices, the number of first network-side devices, or the number of second network-side devices is greater than 1. In this way, a case where a plurality of devices send sensing signals to one device, or one device receives sensing signals sent by a plurality of devices, or one device receives sensing measurement quantities sent by a plurality of devices, and so on may occur, which will not be described in detail later.

In a possible implementation, the method further includes:
receiving, by the first sensing device, a second requirement from a second sensing device; where
the second requirement includes a sensing requirement.

In a possible implementation, the method further includes:
receiving, by the first sensing device, first target information from a second sensing device; or receiving, by the first sensing device, the first target information from a first network-side device; or
receiving, by the first sensing device, the first target information from a second network-side device; where
the first target information includes at least one of the following:
a sensing measurement quantity that needs to be fed back by the first sensing device;
measurement configuration information; and
feedback configuration information for a sensing measurement quantity.

The method further includes:
(1) the first sensing device receives from the second sensing device at least one of a sensing measurement quantity that needs to be fed back by the first sensing device, measurement configuration information, and feedback configuration information for the sensing measurement quantity; or
(2) the first sensing device receives from the first network-side device at least one of a sensing measurement quantity that needs to be fed back by the first sensing device, measurement configuration information, and feedback configuration information for the sensing measurement quantity; or
(3) the first sensing device receives from the second network-side device at least one of a sensing measurement quantity that needs to be fed back by the first sensing device, measurement configuration information, and feedback configuration information for the sensing measurement quantity.

In this embodiment of this application, the first network-side device is an access network device, such as a base station, accessed by the second sensing device in a case that the second sensing device is a terminal. The second network-side device is a sensing network function or a sensing network element and may be located at the RAN side or the core network side, that is, being a network node responsible for at least one of functions of sensing request processing, sensing resource scheduling, sensing information interaction, sensing data processing, and so on in the core network and/or RAN; or may be an AMF or a Location Management Function (LMF) in the 5G network in related technologies, or other network nodes or newly defined network nodes. The concepts about the first network-side device and the second network-side device may be carried forward to other subsequent embodiments.

In a possible implementation, the method further includes:

receiving, by the first sensing device, first information from a second sensing device, where the first information includes parameter information of a sensing signal and/or resource information of the sensing signal.

In a possible implementation, the method further includes:

receiving, by the first sensing device, a first fuzzification mode and/or a second fuzzification mode from a second sensing device.

In a possible implementation, the method further includes:

determining, by the first sensing device, at least one of a sensing measurement quantity that needs to be fed back, the first fuzzification mode, and the second fuzzification mode.

After the first sensing device detects the first sensing signal and obtains the first sensing measurement quantity, the technical solution in this embodiment of this application may further include the following steps.

In a possible implementation, the method further includes:

sending, by the first sensing device, the first sensing measurement quantity to any one of the second sensing device, the first network-side device, and the second network-side device based on the feedback configuration information for the sensing measurement quantity.

In a possible implementation, the method further includes:
obtaining, by the first sensing device, a sensing result based on the first sensing measurement quantity; and
sending, by the first sensing device, the sensing result to any one of the second sensing device, the first network-side device, and the second network-side device.

In a possible implementation, the obtaining, by the first sensing device, a sensing result based on the first sensing measurement quantity includes:
the first sensing device converts the first sensing measurement quantity into a sensing result based on at least one of the first requirement, the second requirement, and a third fuzzification mode; or
the first sensing device converts the first sensing measurement quantity into an initial sensing result, and then converts the initial sensing result into a sensing result based on at least one of the first requirement, the second requirement, and a fourth fuzzification mode.

The third fuzzification mode and the fourth fuzzification mode are used by the first sensing device to perform fuzzification processing during generating of the sensing result, the third fuzzification mode is determined based on the first requirement and/or the second requirement, and the fourth fuzzification mode is determined according to the first requirement and/or the second requirement.

The sensing result can be understood by referring to the description of the sensing measurement quantity, that is, the sensing result may include a first-level sensing result and a second-level sensing result, and the initial sensing result corresponds to the first-level sensing result. In other words, the first sensing device may perform fuzzification processing in the process of obtaining the first-level sensing result based on the first sensing measurement quantity, or the first sensing device may perform fuzzification processing in the process of obtaining the second-level sensing result based on the first-level sensing result, so as to obtain the final sensing result.

In this embodiment of this application, the first sensing device converts the first sensing measurement quantity into a sensing result. Specifically, in the process of obtaining the sensing result, the first sensing device performs fuzzification processing. That is, in addition that the first sensing device may perform fuzzification processing in the process of obtaining the first sensing measurement quantity, the first sensing device may also perform fuzzification processing in the process of converting the first sensing side measurement into the sensing result, which combines fuzzification processing of the sensing result with fuzzification processing of the sensing measurement quantity to further improve privacy security of wireless sensing.

Referring to FIG. 3, an embodiment of this application further provides a sensing signal processing method. The execution subject of the method is a second sensing device, and the method includes:

Step 301: The second sensing device sends a first sensing signal corresponding to first information to a first sensing device, so that the first sensing device performs fuzzification processing on the first sensing signal to obtain a first sensing measurement quantity, or the first sensing device determines an initial sensing measurement quantity based on the first sensing signal, and performs fuzzification processing on the initial sensing measurement quantity to obtain a first sensing measurement quantity.

The first information includes parameter information of a sensing signal and/or resource information of the sensing signal. The first sensing device performs fuzzification processing during generating of a first sensing measurement quantity to obtain the first sensing measurement quantity; or the first sensing device performs fuzzification processing on the initial sensing measurement quantity of the first sensing signal to obtain the first sensing measurement quantity.

Obtaining the first sensing measurement quantity through fuzzification processing includes: obtaining the first sensing measurement quantity based on one or more of the first requirement, the second requirement, a first fuzzification mode, and a second fuzzification mode.

In some embodiments, the first fuzzification mode is determined based on the first requirement and/or the second requirement, and the second fuzzification mode is determined based on the first requirement and/or the second requirement.

The first requirement includes at least one of the following: a fuzzification requirement related to wireless sensing, a sensing privacy requirement, and a sensing error requirement; and the second requirement includes at least one of the following: a sensing target area, a sensing object type, and sensing quality of service QoS. The first fuzzification mode is used for fuzzification processing in the process of obtaining the first sensing measurement quantity. The second fuzzification mode is used for fuzzification processing in the process of converting the initial sensing measurement quantity into the first sensing measurement quantity.

Before the second sensing device sends the first sensing signal corresponding to the first information to the first sensing device and the first sensing device detects the first sensing signal to obtain the first sensing measurement quantity, the technical solution in this embodiment of this application may further include the following steps.

In a possible implementation, the method further includes:

the second sensing device receives the first requirement from a first network-side device or a second network-side device, and the second sensing device determines second information based on the first requirement; or the second sensing device receives the second information from the first network-side device or the second network-side device.

The first requirement includes at least one of the following: a fuzzification requirement related to wireless sensing, a sensing privacy requirement, and a sensing error requirement.

In this embodiment of this application, the second sensing device may determine the second information based on the first requirement received from the first network-side device or the second network-side device, or the second sensing device may directly receive the second information from the first network-side device or the second network-side device.

The second information is used to enable a sensing transmitting device to obtain parameter information and/or resource information related to the sensing signal, so that the sensing transmitting device may perform a subsequent step of sending the first sensing signal to a sensing receiving device based on the second information.

It should be noted that the sensing transmitting device may send the first sensing signal based on the first information, instead of sending the first sensing signal by completely relying on the second information. That is, the first information may be the same as or different from the second information; to be specific, after obtaining the second information, the sensing transmitting device may adjust the parameter information and/or resource information related to the sensing signal based on an actual status or requirement to obtain one piece of first information, and then send the first sensing signal based on the first information.

In a possible implementation, the method further includes:
receiving, by the second sensing device, a second requirement from the first network-side device or the second network-side device; where
the second requirement includes a sensing requirement.

In a possible implementation, that the second sensing device determines the second information based on the first requirement includes:

the second sensing device determines the second information based on the first requirement and the second requirement.

In a possible implementation, the method further includes:

sending, by the second sensing device, a second requirement to the first sensing device.

In a possible implementation, the method further includes:
sending, by the second sensing device, first target information to the first sensing device; where
the first target information includes at least one of the following:
a sensing measurement quantity that needs to be fed back by the first sensing device;
measurement configuration information; and
feedback configuration information for a sensing measurement quantity.

The method further includes:

the second sensing device sends to the first sensing device at least one of a sensing measurement quantity that needs to be fed back by the first sensing device, measurement configuration information, and feedback configuration information for the sensing measurement quantity; or

In a possible implementation, the method further includes:
(1) the second sensing device receives from the first network-side device at least one of a sensing measurement quantity that needs to be fed back by the first sensing device, measurement configuration information, and feedback configuration information for the sensing measurement quantity; or (2) the second sensing device receives from the second network-side device at least one of a sensing measurement quantity that needs to be fed back by the first sensing device, measurement configuration information, and feedback configuration information for the sensing measurement quantity; or
(3) the second sensing device determines at least one of a sensing measurement quantity that needs to be fed back by the first sensing device, measurement configuration information, and feedback configuration information for the sensing measurement quantity.

In a possible implementation, the method further includes:

determining, by the second sensing device, the first fuzzification mode based on the first requirement; or receiving, by the second sensing device, the second fuzzification mode from a second network-side device.

The first fuzzification mode is a fuzzification mode for part or all of measurement quantities, and the second fuzzification mode is a fuzzification mode for part or all of measurement quantities.

In a possible implementation, the method further includes:

sending, by the second sensing device, a first fuzzification mode and/or a second fuzzification mode to the first sensing device.

In a possible implementation, the method further includes:

sending, by the second sensing device, first information to the first sensing device.

The first information includes parameter information of a sensing signal and/or resource information of the sensing signal.

In a possible implementation, the method further includes:

receiving, by the second sensing device, first information from the first network-side device.

After the second sensing device sends the first sensing signal corresponding to the second information to the first sensing device, and the first sensing device detects the first sensing signal to obtain the first sensing measurement quantity, the technical solution in this embodiment of this application may include the following steps.

In a possible implementation, the method further includes:

receiving, by the second sensing device, the first sensing measurement quantity from the first sensing device.

In a possible implementation, the method further includes:

receiving, by the second sensing device, a sensing result from the first sensing device.

In a possible implementation, the method further includes:
sending, by the second sensing device, the first sensing measurement quantity to the first network-side device or the second network-side device;
or
obtaining, by the second sensing device, a sensing result based on the first sensing measurement quantity; and
sending, by the second sensing device, the sensing result to the first network-side device or the second network-side device.

In a possible implementation, the method further includes:

sending, by the second sensing device, a sensing result to the first network-side device or the second network-side device.

In a possible implementation, the obtaining, by the second sensing device, a sensing result based on the first sensing measurement quantity includes:
the second sensing device converts the first sensing measurement quantity into a sensing result based on at least one of the first requirement, the second requirement, and a third fuzzification mode;
or
the second sensing device converts the first sensing measurement quantity into an initial sensing result, and then converts the initial sensing result into a sensing result based on at least one of the first requirement, the second requirement, and a fourth fuzzification mode.

The third fuzzification mode and the fourth fuzzification mode are used by the second sensing device to perform fuzzification processing during generating of the sensing result, the third fuzzification mode is determined based on the first requirement and/or the second requirement, and the fourth fuzzification mode is determined according to the first requirement and/or the second requirement.

In this embodiment of this application, the second sensing device converts the first sensing measurement quantity into a sensing result. Specifically, in the process of obtaining the sensing result, the second sensing device performs fuzzification processing. That is, in addition that the first sensing device may perform fuzzification processing in the process of obtaining the first sensing measurement quantity, the second sensing device may also perform fuzzification processing in the process of converting the first sensing side measurement into the sensing result, which combines fuzzification processing of the sensing result with fuzzification processing of the sensing measurement quantity to further improve privacy security of wireless sensing.

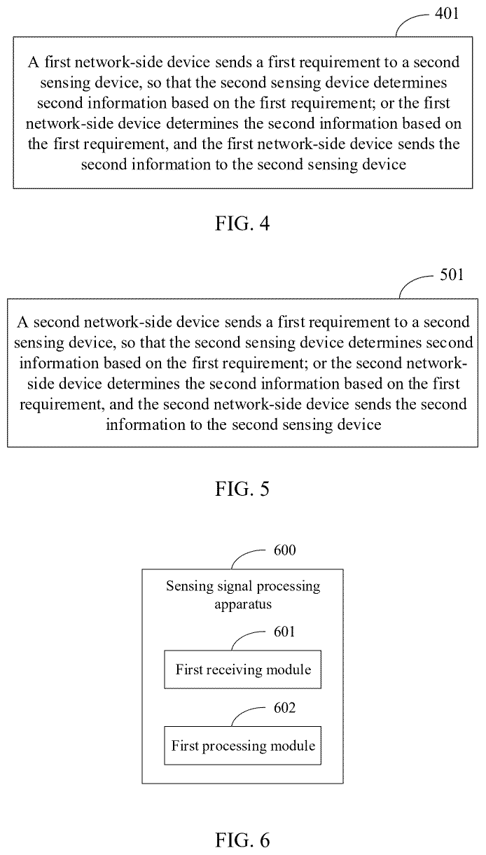

Referring to FIG. 4, an embodiment of this application provides a sensing signal processing method. The execution subject of the method is a first network-side device, and the method includes:

Step 401: The first network-side device sends a first requirement to a second sensing device, so that the second sensing device determines second information based on the first requirement; or the first network-side device determines the second information based on the first requirement, and the first network-side device sends the second information to the second sensing device.

The first requirement includes at least one of the following: a fuzzification requirement related to wireless sensing, a sensing privacy requirement, and a sensing error requirement; and the second information includes at least one of parameter information of a sensing signal and resource information of the sensing signal.

In a possible implementation, the method further includes:
sending, by the first network-side device, a second requirement to the second sensing device; where
the second requirement includes at least one of the following: a sensing target area, a sensing object type, and sensing quality of service QoS.

In a possible implementation, the method further includes:
(1) receiving, by the first network-side device, the first requirement from a core network element; or
(2) receiving, by the first network-side device, the first requirement from an application, a radio access network device, or a terminal; or
(3) receiving, by the first network-side device, the first requirement from a network management system of an operator.

In a possible implementation, the method further includes:
(1) receiving, by the first network-side device, the second requirement from a core network element; or
(2) receiving, by the first network-side device, the second requirement from an application, a radio access network device, or a terminal; or
(3) receiving, by the first network-side device, the second requirement from a network management system of an operator.

In a possible implementation, the method further includes:
sending, by the first network-side device, first target information to a first sensing device; where
the first target information includes at least one of the following:
a sensing measurement quantity that needs to be fed back by the first sensing device;
measurement configuration information; and
feedback configuration information for a sensing measurement quantity.

In a possible implementation, the method further includes:
receiving, by the first network-side device, the first target information from a second network-side device;
or
determining, by the first network-side device, the first target information.

In a possible implementation, the method further includes:
receiving, by the first network-side device, a second fuzzification mode from a second network-side device; and
sending, by the first network-side device, the second fuzzification mode to the second sensing device; where
the second fuzzification mode is used by the first sensing device to perform fuzzification processing during generating of a first sensing measurement quantity, and the second fuzzification mode is a fuzzification mode for part or all of measurement quantities.

In a possible implementation, the method further includes:
sending, by the first network-side device, second information to the second sensing device; where
the second information includes parameter information of a sensing signal and/or resource information of the sensing signal.

The second information is used to enable a sensing transmitting device to obtain parameter information and/or resource information related to the sensing signal, so that the sensing transmitting device may perform a subsequent step of sending the first sensing signal to a sensing receiving device based on the second information.

It should be noted that the sensing transmitting device may not send the first sensing signal by completely relying on the second information. That is, the first information may be the same as or different from the second information; to be specific, after obtaining the second information, the sensing transmitting device may adjust the parameter information and/or resource information related to the sensing signal based on an actual status or requirement to obtain one piece of first information, and then send the first sensing signal based on the first information.

In a possible implementation, the method further includes:
receiving, by the first network-side device, a first sensing measurement quantity from a first sensing device;
or
receiving, by the first network-side device, a sensing result from the first sensing device or the second sensing device.

In a possible implementation, the method further includes:

obtaining, by the first network-side device, a sensing result based on the first sensing measurement quantity.

In a possible implementation, the method further includes:

sending, by the first network-side device, a sensing result to the second network-side device.

In a possible implementation, the obtaining, by the first network-side device, a sensing result based on the first sensing measurement quantity includes:
the first network-side device converts the first sensing measurement quantity into a sensing result based on at least one of the first requirement, the second requirement, and a third fuzzification mode;
or
the first network-side device converts the first sensing measurement quantity into an initial sensing result, and then converts the initial sensing result into a sensing result based on at least one of the first requirement, the second requirement, and a fourth fuzzification mode.

The third fuzzification mode and the fourth fuzzification mode are used by the first network-side device to perform fuzzification processing during generating of the sensing result, the third fuzzification mode is determined based on the first requirement and/or the second requirement, and the fourth fuzzification mode is determined according to the first requirement and/or the second requirement.

Referring to FIG. 5, an embodiment of this application provides a sensing signal processing method. The execution subject of the method is a second network-side device, and the method includes:

Step 501: The second network-side device sends a first requirement to a second sensing device, so that the second sensing device determines second information based on the first requirement; or the second network-side device determines the second information based on the first requirement, and the second network-side device sends the second information to the second sensing device.

The first requirement includes at least one of the following: a fuzzification requirement related to wireless sensing, a sensing privacy requirement, and a sensing error requirement; and the second information includes at least one of parameter information of a sensing signal and resource information of the sensing signal.

In a possible implementation, the method further includes:
sending, by the second network-side device, a second requirement to the second sensing device; where
the second requirement includes at least one of the following: a sensing target area, a sensing object type, and sensing quality of service QoS.

In a possible implementation, the method further includes:
(1) receiving, by the second network-side device, the first requirement from a core network element; or
(2) receiving, by the second network-side device, the first requirement from an application, a radio access network device, or a terminal; or
(3) receiving, by the second network-side device, the first requirement from a network management system of an operator.

In a possible implementation, the method further includes:
(1) receiving, by the second network-side device, the second requirement from a core network element; or
(2) receiving, by the second network-side device, the second requirement from an application, a radio access network device, or a terminal; or
(3) receiving, by the second network-side device, the second requirement from a network management system of an operator.

In a possible implementation, the method further includes:
sending, by the second network-side device, first target information to a second sensing device; where
the first target information includes at least one of the following:
a sensing measurement quantity that needs to be fed back by the first sensing device;
measurement configuration information; and
feedback configuration information for a sensing measurement quantity.

In a possible implementation, the method further includes:
determining, by the second network-side device, a second fuzzification mode based on the first requirement; and
sending, by the second network-side device, the second fuzzification mode to the second sensing device or the first network-side device; where
the second fuzzification mode is used by the first sensing device to perform fuzzification processing during generating of a first sensing measurement quantity, and the second fuzzification mode is a fuzzification mode for part or all of measurement quantities.

In a possible implementation, the method further includes:
(1) receiving, by the second network-side device, the second fuzzification mode from a core network element; or
(2) receiving, by the second network-side device, the second fuzzification mode from an application, a radio access network device, or a terminal; or
(3) receiving, by the second network-side device, the second fuzzification mode from a network management system of an operator.

In a possible implementation, the method further includes:
receiving, by the second network-side device, the first sensing measurement quantity from the second sensing device or a first network-side device;
or
receiving, by the second network-side device, the sensing result from the second sensing device or the first network-side device.

In a possible implementation, the method further includes:

obtaining, by the second network-side device, a sensing result based on the first sensing measurement quantity.

In a possible implementation, the obtaining, by the second network-side device, a sensing result based on the first sensing measurement quantity includes:
the second network-side device converts the first sensing measurement quantity into a sensing result based on at least one of the first requirement, the second requirement, and a third fuzzification mode;
or
the second network-side device converts the first sensing measurement quantity into an initial sensing result, and then converts the initial sensing result into a sensing result based on at least one of the first requirement, the second requirement, and a fourth fuzzification mode.

The third fuzzification mode and the fourth fuzzification mode are used by the second network-side device to perform fuzzification processing during generating of the sensing result, the third fuzzification mode is determined based on the first requirement and/or the second requirement, and the fourth fuzzification mode is determined according to the first requirement and/or the second requirement.

The following describes the technical solutions of this application with specific application examples:

### Example 1

Corresponding to the following three sensing link directions, the common point is that a sensing signal transmitting device is a base station.

Case 1: The sensing signal transmitting device is a base station 1, and a sensing signal receiving device is UE.

Case 2: The sensing signal transmitting device is the base station 1, and the sensing signal receiving device is a base station 2.

Case 3: The sensing signal transmitting device is the base station 1, and the sensing signal receiving device is the base station 1 (that is, echo reception).

The involved execution subjects include:
a first device: a sensing signal transmitting device, such as a base station;
a second device: a sensing network function/sensing network element (SensingMF) that may be located on the RAN side or the core network side, being a network node responsible for at least one function such as sensing request processing, sensing resource scheduling, sensing information interaction, sensing data processing, and the like in the core network and/or the RAN, which may be an upgraded AMF or LMF based on the 5G network in the related technology or may be other network nodes or newly defined network nodes, or core network devices such as a sensing network function/sensing network element (SensingMF); and
a third device: a sensing signal receiving device, such as a base station or UE.

It should be noted that if the first device and the third device are a same device, that is, the sensing link is the foregoing case 3 (echo reception), the signaling interaction steps between the first device and the third device in the following schemes 1 and 2 may be omitted, because the same device does not need signaling interaction.

The specific process is as follows:

The first device receives a first requirement from the second device and determines second information based on the first requirement; or

the first device receives the second information from the second device.

The first requirement includes a fuzzification requirement related to wireless sensing, a sensing privacy requirement, or a sensing error requirement. The second information includes parameter information and/or resource information of the sensing signal.

If the first device receives the second information from the second device, before this step, the second device determines the second information based on the first requirement.

The method for determining/receiving the first requirement by the second device includes at least one of the following:
the first requirement comes from an external application; in this case, the first requirement is sent to an NEF through an AF, and then to AMF; and the AMF selects a Sensing Management Function (SensingMF) and sends the first requirement to the sensing MF; or
the first requirement comes from an external application, the AF sends the first requirement to the NEF, and the NEF selects a sensing MF and sends the first requirement to the sensing MF; or
the first requirement may, for example, come from the base station and/or the UE; in this case, the base station and/or the UE sends the first requirement to the AMF, and the AMF selects a sensing MF and sends the first requirement to the sensing MF.

The first requirement may, for example, come from a supervision department, and then the supervision department send the first requirement to the AMF, and the AMF selects a sensing MF and sends the first requirement to the sensing MF; or the supervision department directly sends the first requirement to the sensing MF; or the supervision department sends the first requirement to the network management system of the operator, and then the network management system sends the first requirement to the sensing MF or sends the first requirement to the sensing MF through the AMF.

Note: the AF or base station or UE sends the first requirement directly to the sensing MF (not being forwarded by the AMF).

According to 1, the first device receives a second requirement from the second device, and the second requirement includes a sensing requirement.

For the method for determining/receiving the second requirement by the second device, refer to the above 3a), 3b), 3c), 3d), and 3e).

In this case, the first device determines second information based on the first requirement and the second requirement.

The first device sends the second requirement to a third device.

The first device sends a sensing measurement quantity that needs to be fed back by the third device and measurement configuration information to the third device.

Before this step, the first device receives from the second device the sensing measurement quantity that needs to be fed back by the third device; or the first device itself determines the sensing measurement quantity that needs to be fed back by the third device, for example, the first device determines, based on the second requirement, the sensing measurement quantity that needs to be fed back by the third device.

The first device determines a first fuzzification mode based on the first requirement (or the first requirement and the second requirement), or the first device receives a second fuzzification mode from the second device; where the first fuzzification mode and the second fuzzification mode are fuzzification modes for part or all of measurement quantities.

According to 6, if the first device receives the second fuzzification mode from the second device, before this step, the second device determines the second fuzzification mode based on the first requirement (or the first requirement and the second requirement), or the second device receives the second fuzzification mode. For a specific receiving manner, refer to 3a), 3b), 3c), 3d), and 3e).

The first device sends the first information to the third device. The first information includes parameter information and/or resource information of the sensing signal, and the first information may be the same as or different from the second information.

The first device sends at least one of the first fuzzification mode and the second fuzzification mode to the third device; or the third device determines at least one of the sensing measurement quantity, the first fuzzification mode and the second fuzzification mode by itself, for example, performing determining based on at least one of the first requirement and the second requirement.

Note: The first fuzzification mode and the second fuzzification mode may be included in the first requirement.

The first device sends the feedback configuration information for the sensing measurement quantity to the third device.

The first device sends a first sensing signal corresponding to the first information to the third device.

The third device detects the first sensing signal to obtain a first sensing measurement quantity.

The third device performs fuzzification processing during generating of the first sensing measurement quantity, for example, the third device performs fuzzification processing during generating of the first sensing measurement quantity based on at least one of the first requirement, the second requirement, the first fuzzification mode, and the second fuzzification mode to obtain the first sensing measurement quantity; or
the third device performs fuzzification processing on an initial sensing measurement quantity to obtain the first sensing measurement quantity, for example, the third device performs fuzzification processing on the initial sensing measurement quantity based on at least one of the first requirement, the second requirement, the first fuzzification mode, and the second fuzzification mode to obtain the first sensing measurement quantity; and
the third device sends the first sensing measurement quantity to the first device or the second device based on the feedback configuration information for the sensing measurement quantity; or
the third device obtains a sensing result based on the first sensing measurement quantity and sends the sensing result to the first device or the second device.

If the third device is a base station device, the third device sends the first sensing measurement quantity or the sensing result to the second device.

If the third device is UE, the third device sends the first sensing measurement quantity or the sensing result to the first device; then, the first device sends the first sensing measurement quantity or the sensing result to the second device.

Note: the third device sends tag information corresponding to the first sensing measurement quantity (such as a sensing signal tag corresponding to the sensing measurement quantity, a time tag and frequency tag of the sensing measurement quantity, a tag of a base station or TRP sending the sensing signal, a tag of an antenna port sending the sensing signal, or a tag of a receive antenna of the third device) to the first device or the second device.

If the third device sends the first sensing measurement quantity to the first device or the second device, the next step is that the first device or the second device obtains the sensing result based on the first sensing measurement quantity.

In some embodiment, “the third device obtains the sensing result based on the first sensing measurement quantity” in the above 12 and “the first device or the second device obtains the sensing result based on the first sensing measurement quantity” in the above 13 are as follows:

The first device, the second device or the third device converts the first sensing measurement quantity into a sensing result based on at least one of the first requirement, the second requirement, and a third fuzzification mode; or

the first device, the second device or the third device converts the first sensing measurement quantity into an initial sensing result, and then converts the initial sensing result into a sensing result based on at least one of the first requirement, the second requirement, and a fourth fuzzification mode.

The third fuzzification mode and/or the fourth fuzzification mode are determined by the first device or the second device based on the first requirement (or the first requirement and the second requirement); or the third fuzzification mode and/or the fourth fuzzification mode are included in the first requirement.

After the first device obtains the sensing result, the first device sends the sensing result to the second device, and the second device sends the sensing result to a sensing requirement party (such as an external application, a base station, and UE); or after the second device obtains the sensing result, the second device sends the sensing result to the sensing requirement party.

The sensing requirement party performs fuzzification processing on the sensing result at the application layer to obtain a fuzzified sensing result.

### Example 2

Corresponding to the following three sensing link directions, the common point is that a sensing signal transmitting device is UE.

Case 1: The sensing signal transmitting device is UE, and a sensing signal receiving device is a base station.

Case 2: The sensing signal transmitting device is UE1, and a sensing signal receiving device is UE2.

Case 3: The sensing signal transmitting device is UE1, and the sensing signal receiving device is the UE1 (that is, echo reception).

The involved execution subjects include:
a first device: a sensing signal transmitting device, such as UE;
a second device: an access base station or serving base station of the first device, that is, an access base station of the UE;
a third device: a sensing network function/sensing network element (SensingMF) that may be located on the RAN side or the core network side, being a network node responsible for at least one function such as sensing request processing, sensing resource scheduling, sensing information interaction, sensing data processing, and the like in the core network and/or the RAN, which may be an upgraded AMF or LMF based on the 5G network in the related technology or may be other network nodes or newly defined network nodes; and
a fourth device: a sensing signal receiving device, such as a base station or UE.

It should be noted that a base station of the second device and a base station of the fourth device may be a same base station or different base stations.

It should be noted that if the first device and the fourth device are a same device, that is, the sensing link is the foregoing case 3 (echo reception), the signaling interaction steps between the first device and the fourth device in Example 2 may be omitted, because the same device does not need signaling interaction.

The specific process is as follows:

The first device receives a first requirement from the second device and determines second information based on the first requirement; or

the first device receives the second information from the second device.

The first requirement includes a fuzzification requirement related to wireless sensing, a sensing privacy requirement, or a sensing error requirement. The second information includes parameter information and/or resource information of the sensing signal.

If the first device receives the second information from the second device, before this step, the second device determines the second information based on the first requirement.

The method for determining/receiving the first requirement by the second device includes at least one of the following: the first requirement comes from an external application; in this case, the first requirement is sent to an NEF through an AF, and then to an AMF, the AMF selects a sensing MF and sends the first requirement to the sensing MF, and the sensing MF sends the first requirement to the second device; or
the first requirement comes from an external application, the AF sends the first requirement to the NEF, and the NEF selects a sensing MF and sends the first requirement to the sensing MF; or
the first requirement may, for example, come from the base station and/or the UE; in this case, the base station and/or the UE sends the first requirement to the AMF, the AMF selects a sensing MF and sends the first requirement to the sensing MF, and the sensing MF sends the first requirement to the second device; or
the first requirement may, for example, come from a supervision department, and then the supervision department send the first requirement to the AMF, and the AMF selects a sensing MF and sends the first requirement to the sensing MF; or the supervision department directly sends the first requirement to the sensing MF; or the supervision department sends the first requirement to the network management system of the operator, and then the network management system sends the first requirement to the sensing MF or sends the first requirement to the sensing MF through the AMF. The sensing MF sends the first requirement to the second device.

The AF, base station, or UE directly sends the first requirement to the sensing MF (not being forwarded by the AMF), and the sensing MF sends the first requirement to the second device.

The first device receives a second requirement from the second device, and the second requirement includes a sensing requirement.

For the method for determining/receiving the second requirement by the second device, refer to the above 3a), 3b), 3c), 3d), and 3e).

In this case, the first device determines second information based on the first requirement and the second requirement.

If the fourth device is UE, the fourth device receives from the second device (or other devices) a sensing measurement quantity that needs to be fed back by the fourth device and measurement configuration information; in this case, the second device receives from the third device the sensing measurement quantity that needs to be fed back by the fourth device; or the second device itself determines the sensing measurement quantity that needs to be fed back by the fourth device and the measurement configuration information, for example, the second device determines the sensing measurement quantity that needs to be fed back by the fourth device and the measurement configuration information based on the second requirement.

If the fourth device is a base station, the fourth device receives the sensing measurement quantity that needs to be fed back by the fourth device and the measurement configuration information from the second device or the third device.

If the fourth device is UE, the second device determines a first fuzzification mode based on the first requirement (or the first requirement and the second requirement) and sends the first fuzzification mode to the fourth device; or the second device receives a second fuzzification mode from the third device and sends the second fuzzification mode to the fourth device.

If the fourth device is a base station, the fourth device receives a third fuzzification mode from the third device; where the first fuzzification mode, the second fuzzification mode, and the third fuzzification mode are fuzzification modes for part or all of measurement quantities.

Before “the second device receives the second fuzzification mode from the third device” in step 6, the third device determines the second fuzzification mode based on the first requirement (or the first requirement and the second requirement), or the third device receives the second fuzzification mode. For a specific receiving manner, refer to 3a), 3b), 3c), 3d), and 3c).

Before “the fourth device receives the third fuzzification mode from the third device” in step 6, the third device determines the third fuzzification mode based on the first requirement (or the first requirement and the second requirement), or the third device receives the third fuzzification mode. For a specific receiving manner, refer to 3a), 3b), 3c), 3d), and 3c).

Note: The first fuzzification mode, the second fuzzification mode, the third fuzzification mode, and the fourth fuzzification mode may be included in the first requirement.

The first device sends the first information from the second device. The first information includes parameter information and/or resource information of the sensing signal, and the first information may be the same as or different from the second information.

The first device sends a first sensing signal corresponding to the first information to the fourth device.

The fourth device detects the first sensing signal to obtain a first sensing measurement quantity.

The fourth device performs fuzzification processing during generating of the first sensing measurement quantity, for example, the fourth device performs fuzzification processing during generating of the first sensing measurement quantity based on at least one of the first requirement, the second requirement, the first fuzzification mode, and the second fuzzification mode to obtain the first sensing measurement quantity; or

the fourth device performs fuzzification processing on an initial sensing measurement quantity to obtain a first sensing measurement quantity, for example, the fourth device performs fuzzification processing on the initial sensing measurement quantity based on at least one of the first requirement, the second requirement, the first fuzzification mode, and the second fuzzification mode to obtain the first sensing measurement quantity.

If the fourth device is UE, the fourth device sends the first sensing measurement quantity to the second device based on the feedback configuration information for the sensing measurement quantity (or forwards it to the second device through the first device, which is equivalent to a sidelink manner), and then the second device sends the first sensing measurement quantity to the third device; or

the fourth device obtains a sensing result based on the first sensing measurement quantity, and sends the sensing result to the second device (or forwards it to the second device through the first device); then, the second device sends the sensing result to the third device.

If the fourth device is a base station device, the fourth device sends the first sensing measurement quantity or the sensing result to the third device.

The fourth device obtains a sensing result based on the first sensing measurement quantity and sends the sensing result to the third device.

Note: the fourth device sends tag information corresponding to the first sensing measurement quantity (such as a sensing signal tag corresponding to the sensing measurement quantity, a time tag and frequency tag of the sensing measurement quantity, a tag of a base station or TRP sending the sensing signal, a tag of an antenna port sending the sensing signal, or a tag of a receive antenna of the third device) to the second device or the third device.

“The fourth device sends the first sensing measurement quantity to the second device or the third device” in the above 10, and the next step is that the second device or the third device obtains a sensing result based on the first sensing measurement quantity.

In some embodiments, “the fourth device obtains the sensing result based on the first sensing measurement quantity” in the above 10 and “the second device or the third device obtains the sensing result based on the first sensing measurement quantity” in the above 11 are as follows:

The fourth device, the second device, or the third device converts the first sensing measurement quantity into a sensing result based on at least one of the first requirement, the second requirement, and a third fuzzification mode; or

the fourth device, the second device, or the third device converts the first sensing measurement quantity into an initial sensing result, and then converts the initial sensing result into a sensing result based on at least one of the first requirement, the second requirement, and a fourth fuzzification mode.

The third fuzzification mode and/or the fourth fuzzification mode are determined based on the first requirement (or the first requirement and the second requirement); or the third fuzzification mode and/or the fourth fuzzification mode are included in the first requirement.

After the second device obtains the sensing result in the above 11, the second device sends the sensing result to the third device, and the third device sends the sensing result to the sensing requirement party (such as an external application, a base station, and UE).

The sensing requirement party performs fuzzification processing on the sensing result at the application layer to obtain a fuzzified sensing result.

In the sensing signal processing method provided in the embodiments of this application, the execution subject may be a sensing signal processing apparatus. In the embodiments of this application, the sensing signal processing apparatus provided by the embodiments of this application is described by using the sensing signal processing method being executed by the sensing signal processing apparatus as an example.

Referring to FIG. 6, an embodiment of this application provides a sensing signal processing apparatus 600, including:
a first receiving module 601, configured for a first sensing device to receive a first sensing signal; and
a first processing module 602, configured to: for the first sensing device, perform fuzzification processing on the first sensing signal to obtain a first sensing measurement quantity; or for the first sensing device, determine an initial sensing measurement quantity based on the first sensing signal, and perform fuzzification processing on the initial sensing measurement quantity to obtain the first sensing measurement quantity.

In some embodiments, the first processing module 602 is configured to:

obtain, for the first sensing device, the first sensing measurement quantity based on one or more of a first requirement, a second requirement, and a first fuzzification mode.

In some embodiments, the first processing module 602 is configured to:
obtain, for the first sensing device, the first sensing measurement quantity based on one or more of the first requirement, the second requirement, and a second fuzzification mode; where
the first requirement includes at least one of the following: a fuzzification requirement related to wireless sensing, a sensing privacy requirement, and a sensing error requirement; and the second requirement includes at least one of the following: a sensing target area, a sensing object type, and sensing quality of service QoS.

In some embodiments, the first receiving module 601 is configured to:
receive, for the first sensing device, a first sensing signal corresponding to first information from a second sensing device; where
the first information includes parameter information of a sensing signal and/or resource information of the sensing signal.

In some embodiments, the first processing module 602 is configured to:

receive, for the first sensing device, first information from a second sensing device, where the first information includes parameter information of a sensing signal and/or resource information of the sensing signal.

In some embodiments, the first processing module 602 is configured to:

receive, for the first sensing device, at least one of the first requirement, the second requirement, the first fuzzification mode, and the second fuzzification mode from a second sensing device.

In some embodiments, the first processing module 602 is configured to:

determine, for the first sensing device, at least one of a sensing measurement quantity that needs to be fed back, the first fuzzification mode, and the second fuzzification mode.

In some embodiments, the first processing module 602 is configured to:
receive, for the first sensing device, first target information from a second sensing device;
or
receive, for the first sensing device, the first target information from a first network-side device;
or
receive, for the first sensing device, the first target information from a second network-side device; where
the first target information includes at least one of the following:
a sensing measurement quantity that needs to be fed back by the first sensing device;
measurement configuration information; and
feedback configuration information for a sensing measurement quantity.

In some embodiments, the first processing module 602 is configured to:

send, for the first sensing device, the first sensing measurement quantity to any one of the second sensing device, the first network-side device, and the second network-side device based on the feedback configuration information for the sensing measurement quantity.

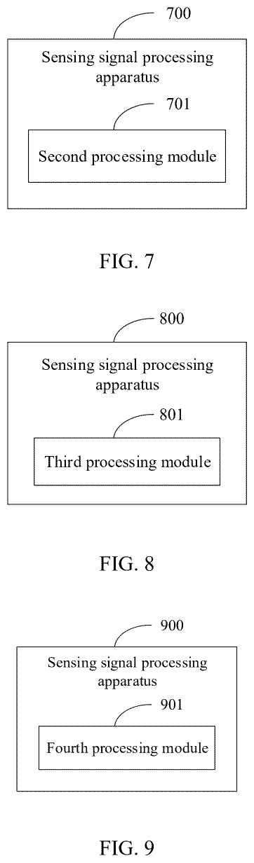

Referring to FIG. 7, an embodiment of this application provides a sensing signal processing apparatus 700, including:
a second processing module 701 configured to: for a second sensing device, send a first sensing signal corresponding to first information to a first sensing device, so that the first sensing device performs fuzzification processing on the first sensing signal to obtain a first sensing measurement quantity, or the first sensing device determines an initial sensing measurement quantity based on the first sensing signal, and performs fuzzification processing on the initial sensing measurement quantity to obtain a first sensing measurement quantity; where
the first information includes parameter information of a sensing signal and/or resource information of the sensing signal.

In some embodiments, the second processing module 701 is configured to:
send, for the second sensing device, the first information to the first sensing device; where
the first information includes parameter information of a sensing signal and/or resource information of the sensing signal.

In some embodiments, the second processing module 701 is configured to:
send, for the second sensing device, at least one of a first requirement, a second requirement, a first fuzzification mode, and a second fuzzification mode to the first sensing device; where
the first requirement includes at least one of the following: a fuzzification requirement related to wireless sensing, a sensing privacy requirement, and a sensing error requirement; the second requirement includes at least one of the following: a sensing target area, a sensing object type, and sensing quality of service QOS; the first fuzzification mode is used by the first sensing device to perform fuzzification processing on the first sensing signal; the second fuzzification mode is used for the first sensing device to perform fuzzification processing on the initial sensing measurement quantity; and the first fuzzification mode is a fuzzification mode for part or all of measurement quantities, and the second fuzzification mode is a fuzzification mode for part or all of measurement quantities.

In some embodiments, the second processing module 701 is configured to:
determine, for the second sensing device, the first fuzzification mode based on the first requirement;
or
receive, for the second sensing device, the second fuzzification mode from a first network-side device or a second network-side device.

In some embodiments, the second processing module 701 is configured to:
receive, for the second sensing device, second information from a first network-side device; where
the second information includes parameter information of a sensing signal and/or resource information of the sensing signal.

In some embodiments, the second processing module 701 is configured to:
receive, for the second sensing device, the first requirement from the first network-side device or a second network-side device, and determine, for the second sensing device, the second information based on the first requirement;
or
receive, for the second sensing device, the second information from the first network-side device or the second network-side device.

In some embodiments, the second processing module 701 is configured to:

receive, for the second sensing device, the second requirement from the first network-side device or the second network-side device.

In some embodiments, the second processing module 701 is configured to:

determine, for the second sensing device, the second information based on the first requirement and the second requirement.

In some embodiments, the second processing module 701 is configured to:
send, for the second sensing device, first target information to the first sensing device; where
the first target information includes at least one of the following:
a sensing measurement quantity that needs to be fed back by the first sensing device;
measurement configuration information; and
feedback configuration information for a sensing measurement quantity.

In some embodiments, the second processing module 701 is configured to:
receive, for the second sensing device, the first target information from a first network-side device;
or
receive, for the second sensing device, the first target information from a second network-side device;
or
determine, for the second sensing device, the first target information.

In some embodiments, the second processing module 701 is configured to:

receive, for the second sensing device, the first sensing measurement quantity from the first sensing device.

In some embodiments, the second processing module 701 is configured to:

send, for the second sensing device, the first sensing measurement quantity to a first network-side device or a second network-side device.

Referring to FIG. 8, an embodiment of this application provides a sensing signal processing apparatus 800, including:
a third processing module 801 configured to: send, for a first network-side device, a first requirement to a second sensing device, so that the second sensing device determines second information based on the first requirement;
or
determine, for the first network-side device, the second information based on the first requirement, and send, for the first network-side device, the second information to the second sensing device; where
the first requirement includes at least one of the following: a fuzzification requirement related to wireless sensing, a sensing privacy requirement, and a sensing error requirement; and the second information includes at least one of parameter information of a sensing signal and resource information of the sensing signal.

In some embodiments, the third processing module 801 is configured to:
send, for the first network-side device, a second requirement to the second sensing device; where
the second requirement includes at least one of the following: a sensing target area, a sensing object type, and sensing quality of service QoS.

In some embodiments, the third processing module 801 is configured to:
receive, for the first network-side device, the first requirement from a core network element;
or
receive, for the first network-side device, the first requirement from an application, a radio access network device, or a terminal;
or
receive, for the first network-side device, the first requirement from a network management system of an operator.

In some embodiments, the third processing module 801 is configured to:
receive, for the first network-side device, the second requirement from a core network element;
or
receive, for the first network-side device, the second requirement from an application, a radio access network device, or a terminal;
or
receive, for the first network-side device, the second requirement from a network management system of an operator.

In some embodiments, the third processing module 801 is configured to:
send, for the first network-side device, first target information to a first sensing device; where
the first target information includes at least one of the following:
a sensing measurement quantity that needs to be fed back by the first sensing device;
measurement configuration information; and
feedback configuration information for a sensing measurement quantity.

In some embodiments, the third processing module 801 is configured to:
receive, for the first network-side device, the first target information from a second network-side device;
or
determine, for the first network-side device, the first target information.

In some embodiments, the third processing module 801 is configured to:
receive, for the first network-side device, a second fuzzification mode from a second network-side device; and
send, for the first network-side device, the second fuzzification mode to the second sensing device; where
the second fuzzification mode is used by the first sensing device to perform fuzzification processing during generating of a first sensing measurement quantity, and the second fuzzification mode is a fuzzification mode for part or all of measurement quantities.

In some embodiments, the third processing module 801 is configured to:

receive, for the first network-side device, a first sensing measurement quantity from a first sensing device.

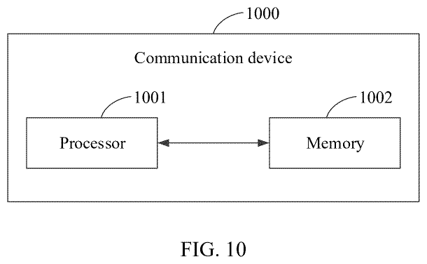

Referring to FIG. 9, an embodiment of this application provides a sensing signal processing apparatus 900, including:
a fourth processing module 901 configured to: send, for a second network-side device, a first requirement to a second sensing device, so that the second sensing device determines second information based on the first requirement;
or
determine, for the second network-side device, the second information based on the first requirement, and send, for the second network-side device, the second information to the second sensing device; where
the first requirement includes at least one of the following: a fuzzification requirement related to wireless sensing, a sensing privacy requirement, and a sensing error requirement; and the second information includes at least one of parameter information of a sensing signal and resource information of the sensing signal.

In some embodiments, the fourth processing module 901 is configured to:
send, for the second network-side device, a second requirement to the second sensing device; where
the second requirement includes at least one of the following: a sensing target area, a sensing object type, and sensing quality of service QoS.

In some embodiments, the fourth processing module 901 is configured to:
receive, for the second network-side device, the first requirement from a core network element;
or
receive, for the second network-side device, the first requirement from an application, a radio access network device, or a terminal;
or
receive, for the second network-side device, the first requirement from a network management system of an operator.

In some embodiments, the fourth processing module 901 is configured to:
receive, for the second network-side device, the second requirement from a core network element;
or receive, for the second network-side device, the second requirement from an application, a radio access network device, or a terminal;
or receive, for the second network-side device, the second requirement from a network management system of an operator.

In some embodiments, the fourth processing module 901 is configured to:
send, for the second network-side device, first target information to a first network-side device or the second sensing device; where the first target information includes at least one of the following:

a sensing measurement quantity that needs to be fed back by the first sensing device;
measurement configuration information; and
feedback configuration information for a sensing measurement quantity.

In some embodiments, the fourth processing module 901 is configured to:
determine, for the second network-side device, a second fuzzification mode based on the first requirement; and
send, for the second network-side device, the second fuzzification mode to the second sensing device or the first network-side device; where the second fuzzification mode is used by the first sensing device to perform fuzzification processing during generating of a first sensing measurement quantity, and the second fuzzification mode is a fuzzification mode for part or all of measurement quantities.

In some embodiments, the fourth processing module 901 is configured to:
receive, for the second network-side device, the second fuzzification mode from a core network element;
or
receive, for the second network-side device, the second fuzzification mode from an application, a radio access network device, or a terminal;
or
receive, for the second network-side device, the second fuzzification mode from a network management system of an operator.

The second fuzzification mode is used by the first sensing device to perform fuzzification processing during generating of a first sensing measurement quantity, and the second fuzzification mode is a fuzzification mode for part or all of measurement quantities.

In some embodiments, the fourth processing module 901 is configured to:

receive, for the second network-side device, a first sensing measurement quantity from the second sensing device or a first network-side device.

The sensing signal processing apparatus in this embodiment of the application may be an electronic device, such as an electronic device with an operating system, or a component in the electronic device, such as an integrated circuit or a chip. The electronic device may be a terminal or other devices than the terminal. For example, the terminal may include, but is not limited to, the types of the terminal 11 listed above, and other devices may be a server, a Network Attached Storage (NAS), and the like. This is not limited in the embodiment of this application.

The sensing signal processing apparatus provided in this embodiment of this application is capable of implementing the processes implemented in the method embodiments in FIG. 2 to FIG. 5, with the same technical effects achieved. To avoid repetition, details are not described herein again.

In some embodiments, as shown in FIG. 10, an embodiment of this application further provides a communication device 1000, including a processor 1001 and a memory 1002, where a program or instructions capable of running on the processor 1001 are stored in the memory 1002. For example, when the communication device 1000 is a terminal and when the program or the instructions are executed by the processor 1001, the steps of the foregoing embodiments of the sensing signal processing method are implemented, with the same technical effects achieved. When the communication device 1000 is a network-side device and when the program or the instructions are executed by the processor 1001, the steps of the foregoing embodiments of the sensing signal processing method are implemented, with the same technical effects achieved. To avoid repetition, details are not described herein again.

An embodiment of this application further provides a terminal, including a processor and a communication interface, where the communication interface is configured to receive, for a first sensing device, a first sensing signal.

The processor is configured to perform, for the first sensing device, fuzzification processing on the first sensing signal to obtain a first sensing measurement quantity;
or
determine, for the first sensing device, an initial sensing measurement quantity based on the first sensing signal, and perform fuzzification processing on the initial sensing measurement quantity to obtain the first sensing measurement quantity.
or
the communication interface is configured to: for a second sensing device, send a first sensing signal corresponding to first information to a first sensing device, so that the first sensing device performs fuzzification processing on the first sensing signal to obtain a first sensing measurement quantity, or the first sensing device determines an initial sensing measurement quantity based on the first sensing signal, and performs fuzzification processing on the initial sensing measurement quantity to obtain a first sensing measurement quantity; where
the first information includes parameter information of a sensing signal and/or resource information of the sensing signal.

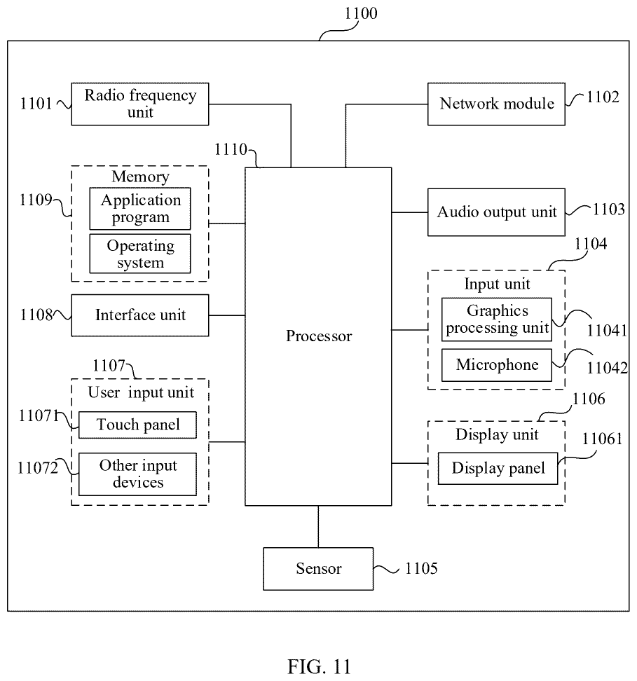

The terminal embodiments correspond to the foregoing method embodiments for the first sensing device and the second sensing device, and the implementation processes and implementations of the foregoing method embodiments can be applied to the terminal embodiments, with the same technical effects achieved. Specifically, FIG. 11 is a schematic diagram of a hardware structure of a terminal for implementing the embodiments of this application.

The terminal 1100 includes but is not limited to at least part of components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

Persons skilled in the art can understand that the terminal 1100 may further include a power supply (for example, a battery) supplying power to the components, and the power supply may be logically connected to the processor 1110 through a power management system. In this way, functions such as charge management, discharge management, and power consumption management are implemented by using the power management system. The structure of the terminal shown in FIG. 11 does not constitute any limitation on the terminal. The terminal may include more or fewer components than shown in the figure, or a combination of some components, or the components disposed differently. Details are not described herein again.

It can be understood that in this embodiment of this application, the input unit 1104 may include a Graphics Processing Unit (GPU) 11041 and a microphone 11042. The graphics processing unit 11041 processes image data of a still picture or video obtained by an image capture apparatus (such as a camera) in a video capture mode or an image capture mode. The display unit 1106 may include a display panel 11061, and the display panel 11061 may be configured in a form of a liquid crystal display, an organic light-emitting diode, and the like. The user input unit 1107 may include at least one of a touch panel 11071 and other input devices 11072. The touch panel 11071 is also referred to as a touchscreen. The touch panel 11071 may include two parts: a touch detection apparatus and a touch controller. The other input devices 11072 may include but are not limited to a physical keyboard, a function key (such as a volume control key or a power on/off key), a trackball, a mouse, a joystick, and the like. Details are not described herein.

In this embodiment of this application, the radio frequency unit 1101 receives downlink data from a network-side device, and then sends the downlink data to the processor 1110 for processing. In addition, the radio frequency unit 1101 may send uplink data to the network-side device. Generally, the radio frequency unit 1101 includes but is not limited to an antenna, an amplifier, a transceiver, a coupler, a low noise amplifier, a duplexer, and the like.

The memory 1109 may be configured to store software programs or instructions and various data. The memory 1109 may include a first storage area for storing a program or instructions and a second storage area for storing data. The first storage area may store an operating system, an application program or instruction required by at least one function (for example, a sound playback function or an image playback function), and the like. In addition, the memory 1109 may include a volatile memory or a non-volatile memory, or the memory 1109 may include both a volatile memory and a non-volatile memory. The non-volatile memory may be a Read-Only Memory (ROM), a Programmable ROM (PROM), an Erasable PROM (EPROM), and an Electrically EPROM (EEPROM), or flash memory. The volatile memory can be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1109 in the embodiments of this application includes but is not limited to these and any other suitable types of memories.

The processor 1110 may include one or more processing units. In some embodiments, an application processor and a modem processor may be integrated in the processor 1110. The application processor primarily processes operations involving an operating system, user interfaces, application programs, and the like. The modem processor primarily processes radio communication signals, for example, being a baseband processor. It can be understood that the modem processor may, for example, be not integrated in the processor 1110.

In a case that the terminal 1100 is a first sensing device, the radio frequency unit 1101 is configured for the first sensing device to receive a first sensing signal.

The processor 1110 is configured to: for the first sensing device, perform fuzzification processing on the first sensing signal to obtain a first sensing measurement quantity; or for the first sensing device, determine an initial sensing measurement quantity based on the first sensing signal and perform fuzzification processing on the initial sensing measurement quantity to obtain the first sensing measurement quantity.

In some embodiments, the processor 1110 is configured to:

obtain, for the first sensing device, the first sensing measurement quantity based on one or more of a first requirement, a second requirement, and a first fuzzification mode.

In some embodiments, the processor 1110 is configured to:
obtain, for the first sensing device, the first sensing measurement quantity based on one or more of the first requirement, the second requirement, and a second fuzzification mode; where
the first requirement includes at least one of the following: a fuzzification requirement related to wireless sensing, a sensing privacy requirement, and a sensing error requirement; and the second requirement includes at least one of the following: a sensing target area, a sensing object type, and sensing quality of service QoS.

In some embodiments, the radio frequency unit 1101 is configured to:
receive, for the first sensing device, a first sensing signal corresponding to first information from a second sensing device; where
the first information includes parameter information of a sensing signal and/or resource information of the sensing signal.

In some embodiments, the radio frequency unit 1101 is configured to:

receive, for the first sensing device, first information from a second sensing device, where the first information includes parameter information of a sensing signal and/or resource information of the sensing signal.

In some embodiments, the radio frequency unit 1101 is configured to:

receive, for the first sensing device, at least one of the first requirement, the second requirement, the first fuzzification mode, and the second fuzzification mode from a second sensing device.

In some embodiments, the processor 1110 is configured to:

determine, for the first sensing device, at least one of a sensing measurement quantity that needs to be fed back, the first fuzzification mode, and the second fuzzification mode.

In some embodiments, the radio frequency unit 1101 is configured to:
receive, for the first sensing device, first target information from a second sensing device;
or
receive, for the first sensing device, the first target information from a first network-side device;
or
receive, for the first sensing device, the first target information from a second network-side device; where
the first target information includes at least one of the following:
a sensing measurement quantity that needs to be fed back by the first sensing device;
measurement configuration information; and
feedback configuration information for a sensing measurement quantity.

In some embodiments, the radio frequency unit 1101 is configured to:

send, for the first sensing device, the first sensing measurement quantity to any one of the second sensing device, the first network-side device, and the second network-side device based on the feedback configuration information for the sensing measurement quantity.

In a case that the terminal 1100 is a second sensing device, the radio frequency unit 1101 is configured to: for a second sensing device, send a first sensing signal corresponding to first information to a first sensing device, so that the first sensing device performs fuzzification processing on the first sensing signal to obtain a first sensing measurement quantity, or the first sensing device determines an initial sensing measurement quantity based on the first sensing signal, and performs fuzzification processing on the initial sensing measurement quantity to obtain a first sensing measurement quantity; where the first information includes parameter information of a sensing signal and/or resource information of the sensing signal.

In some embodiments, the radio frequency unit 1101 is configured to:
send, for the second sensing device, the first information to the first sensing device; where
the first information includes parameter information of a sensing signal and/or resource information of the sensing signal.

In some embodiments, the radio frequency unit 1101 is configured to:
send, for the second sensing device, at least one of a first requirement, a second requirement, a first fuzzification mode, and a second fuzzification mode to the first sensing device; where
the first requirement includes at least one of the following: a fuzzification requirement related to wireless sensing, a sensing privacy requirement, and a sensing error requirement; the second requirement includes at least one of the following: a sensing target area, a sensing object type, and sensing quality of service QOS; the first fuzzification mode is used by the first sensing device to perform fuzzification processing on the first sensing signal; the second fuzzification mode is used for the first sensing device to perform fuzzification processing on the initial sensing measurement quantity; and the first fuzzification mode is a fuzzification mode for part or all of measurement quantities, and the second fuzzification mode is a fuzzification mode for part or all of measurement quantities.

In some embodiments, the processor 1110 is configured to:
determine, for the second sensing device, the first fuzzification mode based on the first requirement;
or
receive, for the second sensing device, the second fuzzification mode from a first network-side device or a second network-side device.

In some embodiments, the radio frequency unit 1101 is configured to:
receive, for the second sensing device, second information from a first network-side device; where
the second information includes parameter information of a sensing signal and/or resource information of the sensing signal.

In some embodiments, the radio frequency unit 1101 is configured to:
receive, for the second sensing device, the first requirement from the first network-side device or a second network-side device, and determine, for the second sensing device, the second information based on the first requirement;
or
receive, for the second sensing device, the second information from the first network-side device or the second network-side device.

In some embodiments, the radio frequency unit 1101 is configured to:

receive, for the second sensing device, the second requirement from the first network-side device or the second network-side device.

In some embodiments, the processor 1110 is configured to:

determine, for the second sensing device, the second information based on the first requirement and the second requirement.

In some embodiments, the radio frequency unit 1101 is configured to:
send, for the second sensing device, first target information to the first sensing device; where
the first target information includes at least one of the following:
a sensing measurement quantity that needs to be fed back by the first sensing device;
measurement configuration information; and
feedback configuration information for a sensing measurement quantity.

In some embodiments, the radio frequency unit 1101 is configured to:
receive, for the second sensing device, the first target information from a first network-side device;
or
receive, for the second sensing device, the first target information from a second network-side device;
or
determine, for the second sensing device, the first target information.

In some embodiments, the radio frequency unit 1101 is configured to:

receive, for the second sensing device, the first sensing measurement quantity from the first sensing device.

In some embodiments, the radio frequency unit 1101 is configured to:

send, for the second sensing device, the first sensing measurement quantity to a first network-side device or a second network-side device.

An embodiment of this application further provides a network-side device, including a processor and a communication interface, where the communication interface is configured to receive, for a first sensing device, a first sensing signal.

The processor is configured to perform, for the first sensing device, fuzzification processing on the first sensing signal to obtain a first sensing measurement quantity;
or
determine, for the first sensing device, an initial sensing measurement quantity based on the first sensing signal, and perform fuzzification processing on the initial sensing measurement quantity to obtain the first sensing measurement quantity;
or
the communication interface is configured to: for a second sensing device, send a first sensing signal corresponding to first information to a first sensing device, so that the first sensing device performs fuzzification processing on the first sensing signal to obtain a first sensing measurement quantity, or the first sensing device determines an initial sensing measurement quantity based on the first sensing signal, and performs fuzzification processing on the initial sensing measurement quantity to obtain a first sensing measurement quantity; where
the first information includes parameter information of a sensing signal and/or resource information of the sensing signal;
or
the communication interface is configured to send, for a first network-side device, a first requirement to a second sensing device, so that the second sensing device determines second information based on the first requirement;
or
determine, for the first network-side device, the second information based on the first requirement, and send, for the first network-side device, the second information to the second sensing device; where
the first requirement includes at least one of the following: a fuzzification requirement related to wireless sensing, a sensing privacy requirement, and a sensing error requirement; and the second information includes at least one of parameter information of a sensing signal and resource information of the sensing signal;
or
the communication interface is configured to send, for a second network-side device, a first requirement to a second sensing device, so that the second sensing device determines second information based on the first requirement;
or
determine, for the second network-side device, the second information based on the first requirement, and send, for the second network-side device, the second information to the second sensing device; where
the first requirement includes at least one of the following: a fuzzification requirement related to wireless sensing, a sensing privacy requirement, and a sensing error requirement; and the second information includes at least one of parameter information of a sensing signal and resource information of the sensing signal.

The network-side device embodiments correspond to the foregoing method embodiments for the first sensing device, the second sensing device, the first network-side device, and the second network-side device, and the implementation processes and implementations of the foregoing method embodiments can be applied to the network-side device embodiments, with the same technical effects achieved.

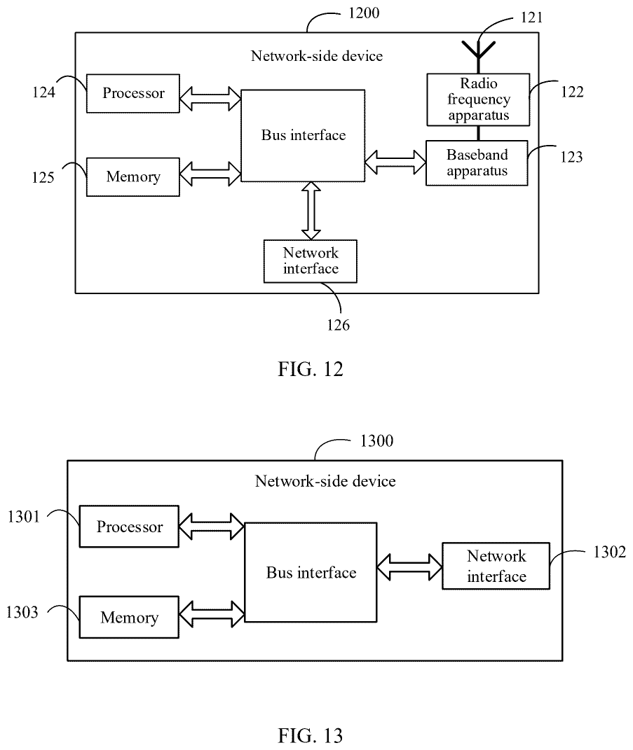

Specifically, an embodiment of this application further provides a network-side device, where the network-side device may be a first sensing device, a second sensing device and a first network-side device. As shown in FIG. 12, the network-side device 1200 includes an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information by using the antenna 121, and sends the received information to the baseband apparatus 123 for processing. In a downlink direction, the baseband apparatus 123 processes to-be-sent information, and sends the information to the radio frequency apparatus 122; and the radio frequency apparatus 122 processes the received information and then sends the information out by using the antenna 121.

The methods executed by the first sensing device, the second sensing device, and the first network-side device in the foregoing embodiments can be implemented in the baseband apparatus 123, and the baseband apparatus 123 includes a baseband processor.

The baseband apparatus 123 may include, for example, at least one baseband board, where a plurality of chips are disposed on the baseband board. As shown in FIG. 12, one of the chips is, for example, a baseband processor, and is connected to the memory 125 through the bus interface, to invoke a program in the memory 125 to perform the operations of the network device shown in the foregoing method embodiments.

The network-side device may further include a network interface 126, where the interface is, for example, a Common Public Radio Interface (CPRI).

Specifically, the network-side device 1200 in this embodiment of this application further includes: instructions or a program stored in the memory 125 and capable of running on the processor 124. The processor 124 invokes the instructions or program in the memory 125 to execute the method executed by the modules shown in FIGS. 6, 7, and 8, with the same technical effects achieved. To avoid repetition, details are not repeated herein.

Specifically, an embodiment of this application further provides a network-side device, where the network-side device may be the foregoing second network-side device. As shown in FIG. 13, the network-side device 1300 includes a processor 1301, a network interface 1302, and a memory 1303. The network interface 1302 is, for example, a CPRI.

Specifically, the network-side device 1300 in this embodiment of this application further includes: instructions or a program stored in the memory 1303 and capable of running on the processor 1301. The processor 1301 invokes the instructions or program in the memory 1303 to execute the method executed by the modules shown in FIG. 9, with the same technical effects achieved. To avoid repetition, details are not repeated herein.

An embodiment of this application further provides a readable storage medium, where a program or an instruction is stored in the readable storage medium. When the program or the instruction is executed by a processor, the processes of the foregoing embodiment of the sensing signal processing method can be implemented, with the same technical effects achieved. To avoid repetition, details are not described herein again.

The processor is a processor in the terminal described in the foregoing embodiments. The readable storage medium includes a computer-readable storage medium, for example, a computer read only memory ROM, a random access memory RAM, a magnetic disk, or an optical disc.

An embodiment of this application further provides a chip, where the chip includes a processor and a communication interface. The communication interface is coupled to the processor, and the processor is configured to run a program or an instruction to implement the processes of the foregoing embodiment of the sensing signal processing method, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a storage medium, and when being executed by at least one processor, the computer program/program product is configured to implement the processes of the foregoing sensing signal processing method embodiments, with the same technical effects achieved. To avoid repetition, details are not repeated herein.

An embodiment of this application further provides a sensing signal processing system, including: a first sensing device, a second sensing device, a first network-side device, and a second network-side device; where
the first network-side device is an access network device accessed by the second sensing device in a case that the second sensing device is a terminal;
the second network-side device is a sensing network function or a sensing network element; and
the first sensing device may be configured to perform the steps of the sensing signal processing method shown in FIG. 2, the second sensing device may be configured to perform the steps of the sensing signal processing method shown in FIG. 3, the first network-side device may be configured to perform the steps of the sensing signal processing method shown in FIG. 4, and the second network-side device may be configured to perform the steps of the sensing signal processing method shown in FIG. 5.

It should be noted that in this specification, the term “include”, “comprise”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described method may be performed in an order different from the order described, and steps may be added, omitted, or combined. In addition, features described with reference to some examples may be combined in other examples.

According to the description of the foregoing implementations, persons skilled in the art can clearly understand that the method in the foregoing embodiments may be implemented by software in combination with a necessary general hardware platform. Certainly, the method in the foregoing embodiments may, for example, be implemented by hardware. However, in many cases, the former is an exemplary implementation. Based on such an understanding, the technical solutions of this application essentially or the part contributing to the related art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A sensing signal processing method, comprising:
receiving, by a first sensing device, a first sensing signal; and
performing, by the first sensing device, fuzzification processing on the first sensing signal to obtain a first sensing measurement quantity;
or
determining, by the first sensing device, an initial sensing measurement quantity based on the first sensing signal, and performing fuzzification processing on the initial sensing measurement quantity to obtain the first sensing measurement quantity.

2. The method according to claim 1, wherein the performing, by the first sensing device, fuzzification processing on the first sensing signal to obtain the first sensing measurement quantity comprises:
obtaining, by the first sensing device, the first sensing measurement quantity based on at least one of a first requirement, a second requirement, or a first fuzzification mode;
the step of performing, by the first sensing device, fuzzification processing on the initial sensing measurement quantity to obtain the first sensing measurement quantity comprises:
obtaining, by the first sensing device, the first sensing measurement quantity based on at least one of the first requirement, the second requirement, or a second fuzzification mode,
wherein the first requirement comprises at least one of the following: a fuzzification requirement related to wireless sensing, a sensing privacy requirement, or a sensing error requirement; and the second requirement comprises at least one of the following: a sensing target area, a sensing object type, or sensing Quality of Service (QOS).

3. The method according to claim 1, wherein the receiving, by the first sensing device, the first sensing signal comprises:
receiving, by the first sensing device, the first sensing signal corresponding to first information from a second sensing device,
wherein the first information comprises parameter information of a sensing signal or resource information of the sensing signal.

4. The method according to claim 1, further comprising:
receiving, by the first sensing device, first information from a second sensing device, wherein the first information comprises parameter information of a sensing signal or resource information of the sensing signal.

5. The method according to claim 1, further comprising:
receiving, by the first sensing device, first target information from a second sensing device; or
receiving, by the first sensing device, the first target information from a first network-side device; or
receiving, by the first sensing device, the first target information from a second network-side device,
wherein the first target information comprises at least one of the following:
a sensing measurement quantity fed back by the first sensing device;
measurement configuration information; or
feedback configuration information for a sensing measurement quantity.

6. A sensing signal processing method, comprising:
sending, by a second sensing device, a first sensing signal corresponding to first information to a first sensing device, so that the first sensing device performs fuzzification processing on the first sensing signal to obtain a first sensing measurement quantity, or the first sensing device determines an initial sensing measurement quantity based on the first sensing signal, and performs fuzzification processing on the initial sensing measurement quantity to obtain a first sensing measurement quantity;
wherein the first information comprises parameter information of a sensing signal or resource information of the sensing signal.

7. The method according to claim 6, further comprising:
sending, by the second sensing device, the first information to the first sensing device;
wherein the first information comprises parameter information of a sensing signal or resource information of the sensing signal.

8. The method according to claim 6, further comprising:
sending, by the second sensing device, at least one of a first requirement, a second requirement, a first fuzzification mode, or a second fuzzification mode to the first sensing device;
wherein the first requirement comprises at least one of the following: a fuzzification requirement related to wireless sensing, a sensing privacy requirement, or a sensing error requirement; the second requirement comprises at least one of the following: a sensing target area, a sensing object type, or sensing Quality of Service (QOS); the first fuzzification mode is used by the first sensing device to perform fuzzification processing on the first sensing signal; the second fuzzification mode is used for the first sensing device to perform fuzzification processing on the initial sensing measurement quantity; and the first fuzzification mode is a fuzzification mode for part or all of measurement quantities, and the second fuzzification mode is a fuzzification mode for part or all of measurement quantities.

9. The method according to claim 8, further comprising:
determining, by the second sensing device, the first fuzzification mode based on the first requirement; or
receiving, by the second sensing device, the second fuzzification mode from a first network-side device or a second network-side device.

10. The method according to claim 8, further comprising:
receiving, by the second sensing device, second information from a first network-side device,
wherein the second information comprises parameter information of a sensing signal or resource information of the sensing signal.

11. The method according to claim 10, further comprising:
receiving, by the second sensing device, the first requirement from the first network-side device or a second network-side device, and determining, by the second sensing device, the second information based on the first requirement; or
receiving, by the second sensing device, the second information from the first network-side device or the second network-side device.

12. The method according to claim 11, further comprising:
receiving, by the second sensing device, the second requirement from the first network-side device or the second network-side device.

13. The method according to claim 8, further comprising:
sending, by the second sensing device, first target information to the first sensing device;
wherein the first target information comprises at least one of the following:
a sensing measurement quantity fed back by the first sensing device;
measurement configuration information; or
feedback configuration information for a sensing measurement quantity.

14. The method according to claim 6, further comprising:
receiving, by the second sensing device, the first sensing measurement quantity from the first sensing device.

15. The method according to claim 14, further comprising:
sending, by the second sensing device, the first sensing measurement quantity to a first network-side device or a second network-side device.

16. A sensing signal processing method, comprising:
sending, by a first network-side device, a first requirement to a second sensing device, so that the second sensing device determines second information based on the first requirement; or
determining, by the first network-side device, the second information based on the first requirement, and sending, by the first network-side device, the second information to the second sensing device,
wherein the first requirement comprises at least one of the following: a fuzzification requirement related to wireless sensing, a sensing privacy requirement, or a sensing error requirement; and the second information comprises at least one of parameter information of a sensing signal or resource information of the sensing signal.

17. The method according to claim 16, further comprising:
sending, by the first network-side device, a second requirement to the second sensing device;
wherein the second requirement comprises at least one of the following: a sensing target area, a sensing object type, or sensing Quality of Service (QOS).

18. The method according to claim 16, further comprising:
receiving, by the first network-side device, the first requirement from a core network element; or
receiving, by the first network-side device, the first requirement from an application, a radio access network device, or a terminal; or
receiving, by the first network-side device, the first requirement from a network management system of an operator.

19. The method according to claim 16, further comprises:
sending, by the first network-side device, first target information to a first sensing device;
wherein the first target information comprises at least one of the following:
a sensing measurement quantity fed back by the first sensing device;
measurement configuration information; or
feedback configuration information for a sensing measurement quantity.

20. The method according to claim 16, further comprising:
receiving, by the first network-side device, a second fuzzification mode from a second network-side device; or
sending, by the first network-side device, the second fuzzification mode to the second sensing device,
wherein the second fuzzification mode is used by the first sensing device to perform fuzzification processing during generating of a first sensing measurement quantity, and the second fuzzification mode is a fuzzification mode for part or all of measurement quantities.

21. A terminal, comprising a processor and a memory storing instructions, wherein the instructions, when executed by the processor, cause the processor to perform operations comprising:
receiving a first sensing signal; and
performing fuzzification processing on the first sensing signal to obtain a first sensing measurement quantity;
or
determining an initial sensing measurement quantity based on the first sensing signal, and performing fuzzification processing on the initial sensing measurement quantity to obtain the first sensing measurement quantity.

22. A terminal, comprising a processor and a memory storing instructions, wherein the instructions, when executed by the processor, cause the processor to perform operations comprising:
sending a first sensing signal corresponding to first information to a first sensing device, so that the first sensing device performs fuzzification processing on the first sensing signal to obtain a first sensing measurement quantity, or the first sensing device determines an initial sensing measurement quantity based on the first sensing signal, and performs fuzzification processing on the initial sensing measurement quantity to obtain a first sensing measurement quantity;
wherein the first information comprises parameter information of a sensing signal or resource information of the sensing signal.

23. A network-side device, comprising a processor and a memory storing instructions, wherein the instructions, when executed by the processor, cause the processor to perform operations comprising:
sending a first requirement to a second sensing device, so that the second sensing device determines second information based on the first requirement; or
determining the second information based on the first requirement, and sending, by the first network-side device, the second information to the second sensing device,
wherein the first requirement comprises at least one of the following: a fuzzification requirement related to wireless sensing, a sensing privacy requirement, or a sensing error requirement; and the second information comprises at least one of parameter information of a sensing signal or resource information of the sensing signal.
